(19) United States
(12) Patent Application Publication
(10) Pub. No.: US 2015/0037576 A1
(43) Pub. Date: Feb. 5, 2015

(54) PRESSURE-SENSITIVE ADHESIVE SHEET AND OPTICAL MEMBER

(71) Applicant: NITTO DENKO CORPORATION, Osaka (JP)

(72) Inventors: Kenichi KATAOKA, Osaka (JP); Tatsumi AMANO, Osaka (JP); Kenjiro NIIMI, Osaka (JP); Hiromoto HARUTA, Osaka (JP)

(73) Assignee: NITTO DENKO CORPORATION, Osaka (JP)

(21) Appl. No.: 14/446,624

(22) Filed: Jul. 30, 2014

(30) Foreign Application Priority Data
Jul. 31, 2013 (JP) 2013-159783

(51) Int. Cl. C09J 7/02

(52) U.S. Cl. CPC C09J 7/0217; C09J 2433/00; C09J 133/08
USPC 428/354

(57) ABSTRACT

A pressure-sensitive adhesive sheet having a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, wherein the top coat layer contains wax as a lubricant and a polyester resin as a binder and having the properties as defined.

### TECHNICAL FIELD

The present invention relates to a pressure-sensitive adhesive sheet and an optical member.

The pressure-sensitive adhesive sheet of the present invention is useful as a surface protective film for the purpose of protecting the surface of an optical member such as a polarizing plate, a wavelength plate, a retardation plate, an optical compensation film, a reflective sheet, or a brightness enhancement film to be used in a liquid crystal display.

### DESCRIPTION OF THE RELATED ART

In recent years, for transportation of optical or electronic components or mounting of optical or electronic components on printed boards, each component is often packed with a given sheet, or a pressure-sensitive adhesive tape is often bonded to each component, before transfer. In particular, surface protecting films are widely used in the field of optical or electronic components.

A surface protective film is generally used for the purpose of preventing a scratch or a stain caused during processing or conveyance of an object to be protected by bonding to the object to be protected through pressure-sensitive adhesive applied on a supporting film side (Patent Document 1). For example, a panel of a liquid crystal display is formed by bonding optical members such as a polarizing plate and a wavelength plate to a liquid crystal cell through a pressure-sensitive adhesive. A surface protective film is bonded to these optical members through a pressure-sensitive adhesive, and the optical members are protected from a scratch or a stain caused during processing or conveyance of an object to be protected.

The surface protective film is peeled and removed when it becomes unnecessary, but along with upsizing and thinning of a liquid crystal display panel, damages on a polarizing plate and a liquid crystal cell is likely to arise during the peeling step, and it is therefore required to ensure light peeling during peeling at high speed.

Further, a surface protective film is required to have performance that the surface protective film is hardly abraded while being bonded to an adherend (e.g., a polarizing plate) at the time of appearance inspection. It is because if abrasions exist in the surface protective film, it leads to the problem of impossibility to determine whether the abrasions are on the adherend or are abrasions of the surface protective film itself.

One of techniques for making the rear surface of the surface protective film hard to be abraded includes a technique for forming a hard surface layer (a top coat layer) on the rear surface. A top coat layer is typically formed by applying a coating material to the rear surface of a substrate and drying and curing the coating material. If a top coat layer has proper slip properties, higher abrasion resistance properties (scratching-resistant properties) can be attained.

An additive (a lubricant) that is generally used for providing the top coat layer with slip properties is a silicone-based lubricant, a fluorine-based lubricant, or the like.

However, in the case of a top coat layer using a silicone-based lubricant, if the top coat layer is exposed to high temperature and high humidity conditions, the top coat layer becomes whitey in the appearance, so-called a whitening phenomenon is caused to lower the visibility at the time of the above-mentioned appearance inspection.

### PRIOR ART DOCUMENT

### Patent Document

Patent Document 1: JP-A-9-165460

### SUMMARY OF THE INVENTION

### Problem to be Solved by the Invention

Accordingly, in order to solve the problems of a conventional pressure-sensitive adhesive sheet, an object of the present invention is to provide a pressure-sensitive adhesive sheet (a surface protective film) having a top coat layer which is excellent in adherability, removability, pick-up properties, and workability, can prevent an increase in adhesive strength over time, and is excellent in whitening resistance.

### Means for Solving the Problems

That is, the pressure-sensitive adhesive sheet of the present invention has a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, wherein the top coat layer contains wax as a lubricant and a polyester resin as a binder and an adhesive strength ratio (A/B) of the rear surface adhesive strength (A) at a peel rate of 0.3 m/min after the surface of the top coat layer is bonded at 23° C. for 30 minutes and the adhesive strength (B) at a peel rate of 30 m/min after the pressure-sensitive adhesive surface of the pressure-sensitive adhesive layer is bonded to a TAC surface at 50° C. for 1 week is 3 or higher.

In the pressure-sensitive adhesive sheet of the present invention, the adhesive strength (B) is preferably 1.5 N/25 mm or lower.

In the pressure-sensitive adhesive sheet of the present invention, the pressure-sensitive adhesive composition preferably contains a (meth)acryl-based polymer containing a hydroxyl group and a carboxyl group.

The pressure-sensitive adhesive sheet of the present invention is preferable to contain the carboxyl group-containing (meth) acryl-based monomer in an amount of 2% by weight or less based on the total weight of the monomer components constituting the (meth)acryl-based polymer.

The pressure-sensitive adhesive sheet of the present invention is preferable to contain the hydroxyl group-containing (meth) acryl-based monomer in an amount of 15% by weight or less based on the total weight of the monomer components constituting the (meth)acryl-based polymer.

The pressure-sensitive adhesive sheet of the present invention is preferable to contain a (meth) acryl-based monomer containing an alkyl group of 1 to 14 carbon atoms in an amount of 50% by weight or more based on the total weight of the monomer components constituting the (meth)acryl-based polymer.

In the pressure-sensitive adhesive sheet of the present invention, the pressure-sensitive adhesive composition preferably contains a crosslinking agent.

In the pressure-sensitive adhesive sheet of the present invention, the pressure-sensitive adhesive composition preferably contains an organopolysiloxane having an oxyalkylene chain.

In the pressure-sensitive adhesive sheet of the present invention, the pressure-sensitive adhesive composition preferably contains an ionic compound.

In the pressure-sensitive adhesive sheet of the present invention, the wax is preferably an ester of a higher fatty acid and a higher alcohol.

In the pressure-sensitive adhesive sheet of the present invention, the top coat layer preferably contains an antistatic component.

The optical member of the present invention is preferably an optical member protected with the pressure-sensitive adhesive sheet.

### BRIEF DESCRIPTION OF THE DRAWINGS

FIG. 1 is an explanatory view for illustrating a method for measuring the rear surface adhesive strength (A);

FIG. 2 is an explanatory view for illustrating a method for peeling off a pressure-sensitive adhesive sheet of one embodiment; and

FIG. 3 is a schematic construction view of a potential measurement part used for the measurement of peeling electrification voltage in Examples and the like.

### DETAILED DESCRIPTION OF THE PREFERRED EMBODIMENTS

Hereinafter, embodiments of the present invention will be described in detail.

### <Pressure-Sensitive Adhesive Composition>

The pressure-sensitive adhesive sheet of the present invention is a pressure-sensitive adhesive sheet having a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film. The pressure-sensitive adhesive composition may be used without particular limitation as long as it has adherability, and for example, all kind pressure-sensitive adhesives such as acrylic, synthetic rubber, natural rubber, and silicone-based ones can be used. In terms of easiness for adjusting the adhesive properties, etc., the use of an acrylic pressure-sensitive adhesive is a more preferable embodiment.

In the pressure-sensitive adhesive sheet of the present invention, the pressure-sensitive adhesive composition preferably contains a (meth)acryl-based polymer. The reasons for the use of an acrylic pressure-sensitive adhesive (pressure-sensitive adhesive composition) using the (meth) acryl-based polymer for the pressure-sensitive adhesive sheet are easiness for adjusting the adhesive properties, transparency, heat resistance, etc.

### <(Meth)Acryl-Based Polymer>

The (meth)acryl-based polymer is not particularly limited as long as the polymer may be a (meth) acryl-based polymer having adherability. It is preferable to contain a (meth) acryl-based monomer containing an alkyl group of 1 to 14 carbon atoms as a main component of monomer components and preferably a (meth) acryl-based monomer containing an alkyl group of 6 to 14 carbon atoms. One or more kinds of the (meth)acryl-based monomers may be used as the main component.

In particular, the content of the (meth)acryl-based monomer containing an alkyl group of 1 to 14 carbon atoms is preferably 50% by weight or more, more preferably 60% by weight or more, furthermore preferably 70% by weight or more, and even more preferably 90 to 97% by weight based on the total weight of the monomer components constituting the (meth)acryl-based polymer. If the content is less than 50% by weight, the proper wettability and cohesive force of the pressure-sensitive adhesive composition are lowered, and thus it is not preferable. In the present invention, the (meth) acryl-based polymer refers to an acryl-based polymer and/or a methacryl-based polymer, and the (meth)acrylate refers to acrylate and/or methacrylate.

Specific examples of the (meth)acryl-based monomer containing an alkyl group of 1 to 14 carbon atoms include methyl (meth)acrylate, ethyl(meth)acrylate, n-butyl (meth)acrylate, sec-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate.

Especially, in the case where the pressure-sensitive adhesive sheet of the present invention is used as a surface protective film, preferable examples include (meth)acrylates containing an alkyl group of 6 to 14 carbon atoms such as hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate. The use of (meth)acrylate containing an alkyl group of 6 to 14 carbon atoms makes it easy to control the adhesive strength to an adherend to be low and gives excellent removability.

The pressure-sensitive adhesive composition to be used in the present invention is preferable to contain a (meth)acryl-based polymer containing a hydroxyl group and a carboxyl group. The use of the (meth)acryl-based polymer containing a hydroxyl group and a carboxyl group is a preferable embodiment since the hydroxyl group makes it easy to control crosslinking and the carboxyl group prevents an increase in adhesive strength over time.

The content of the hydroxyl group-containing (meth) acryl-based monomer is preferably 15% by weight or less, more preferably 1 to 13% by weight, furthermore preferably 2 to 11% by weight, and even more preferably 3.5 to 10% by weight based on the total weight of the monomer components constituting the (meth)acryl-based polymer. If the content falls within the range, the wettability and cohesive force of the pressure-sensitive adhesive composition are easily controlled in good balance, and thus it is preferable. In particular, the use of the hydroxyl group-containing (meth) acryl-based monomer makes the crosslinking of the pressure-sensitive adhesive composition, etc., easily controllable, and consequently makes the balance between an improvement in wettability due to fluidity and a decrease in adhesive strength at the time of peeling controllable. Further, different from a carboxyl group, a sulfonate group, or the like which may possibly act in general as a crosslinking site, a hydroxyl group has a proper interaction with an ionic compound serving as an antistatic agent and an organopolysiloxane having an oxyalkylene chain, and is therefore preferably used in terms of antistatic properties. In the case of improving particularly creep properties, the content is preferably 11 to 15% by weight.

Examples of the hydroxyl group-containing (meth)acryl-based monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, and diethylene glycol monovinyl ether. In particular, the use of a (meth) acryl-based monomer having a hydroxyl group containing an alkyl group of 4 or more carbon atoms is preferable since light peelability at the time of high speed peeling can be obtained easily.

The content of the carboxyl group-containing (meth)acryl-based monomer is preferably 2% by weight or less, more preferably 0.005 to 2% by weight, furthermore preferably 0.006 to 1.9% by weight, and even more preferably 0.01 to 1.0% by weight based on the total weight of the monomer components constituting the (meth)acryl-based polymer. If the content exceeds 2% by weight, an increase in adhesive strength over time cannot be suppressed, and the removability, ability to prevent an increase in adhesive strength, and workability are inferior, and thus it is not preferable. Further, in the case where an ionic compound is added as an antistatic agent if a large number of an acidic functional group such as a carboxyl group with high polar action exist, the interaction of the acidic functional group such as a carboxyl group and the ionic compound is caused to probably inhibit ion conduction, lower the conduction efficiency, and fail to obtain sufficient antistatic properties, and thus it is not preferable.

Examples of the (meth)acryl-based monomer containing a carboxyl group include (meth)acrylic acid, carboxylethyl (meth)acrylate, and carboxylpentyl (meth)acrylate.

As other polymerizable monomer components, a polymerizable monomer for adjusting the glass transition temperature or peelability of the (meth) acryl-based polymer so as to set the Tg to 0° C. or lower (usually −100° C. or higher), and the like may be used to an extent that the effects of the present invention are not deteriorated since the pressure-sensitive adhesive performance can be well balanced.

The other polymerizable monomers to be used for the (meth)acryl-based polymer other than the carboxyl group-containing (meth)acryl-based monomer, the hydroxyl group-containing (meth)acryl-based monomer, and the (meth) acryl-based monomer containing an alkyl group of 1 to 14 carbon atoms can be used without particular limitation as long as the other polymerizable monomer is used to an extent that the characteristics of the present invention are not deteriorated. Examples to be used properly include components for improving cohesive force and heat resistance such as cyano group-containing monomers, vinyl ester monomers, and aromatic vinyl monomers; and components containing functional groups for improving adhesive (adhering) strength and serving as crosslinking base points such as amide group-containing monomers, imide group-containing monomers, amino group-containing monomers, epoxy group-containing monomers, N-acryloylmorpholine, and vinyl ether monomers. These polymerizable monomers may be used singly or in the form of a mixture of two or more of them.

Examples of the cyano group-containing monomer include acrylonitrile and methacrylonitrile.

Examples of vinylesters include vinyl acetate, vinyl propionate, and vinyl laurate.

Examples of the aromatic vinyl compound include styrene, chlorostyrene, chloromethylstyrene, α-methylstyrene, and other substituted styrene.

Examples of the amido group-containing monomer include acrylamide, methacrylamide, diethylacrylamide, N-vinylpyrrolidone, N,N-dimethylacrylamide, N, N-dimethylmethacrylamide, N,N-diethylacrylamide, N, N-diethylmethacrylamide, N,N′-methylenebisacrylamide, N, N-dimethylaminopropylacrylamide, N, N-dimethylaminopropylmethacrylamide, and diacetoneacrylamide.

Examples of the imido group-containing monomer include cyclohexylmaleimide, isopropylmaleimide, N-cyclohexylmaleimide, and itaconeimide.

Examples of the amino group-containing monomer include aminoethyl (meth)acrylate, N,N-dimethylaminoethyl (meth)acrylate, and N,N-dimethylaminopropyl (meth)acrylate.

Examples of the epoxy group-containing monomer include glycidyl (meth)acrylate, methylglycidyl (meth)acrylate, and allyl glycidyl ether.

Examples of vinyl ethers include methyl vinyl ether, ethyl vinyl ether, and isobutyl vinyl ether.

In the present invention, the content of the other polymerizable monomers other than the carboxyl group-containing (meth)acryl-based monomer, the hydroxyl group-containing (meth)acryl-based monomer, and the (meth)acryl-based monomer containing an alkyl group of 1 to 14 carbon atoms is preferably 0 to 40% by weight, and more preferably 0 to 30% by weight in the total weight of the monomer components (all monomer components) constituting the (meth)acryl-based polymer. The use of the other polymerizable monomers in the above-mentioned range makes it possible to provide good interaction with the ionic compound usable as an antistatic agent and to properly adjust the good removability.

In the pressure-sensitive adhesive composition of the present invention, the (meth)acryl-based polymer may further contain an alkylene oxide group-containing reactive monomer as a monomer component.

The average addition mole number of the oxyalkylene unit of the alkylene oxide group-containing reactive monomer is preferably 1 to 40, more preferably 3 to 40, furthermore preferably 4 to 35, and particularly preferably 5 to 30 in terms of compatibility with the ionic compound. In the case where the average addition mole number is 1 or higher, the stain decrease effect on an object to be protected tends to be exhibited effectively. In the case where the average addition mole number is higher than 40, the interaction with the ionic compound tends to be significant, and the viscosity of the pressure-sensitive adhesive composition is increased to result in difficulty of application, and therefore it is not preferable. The terminal of the oxyalkylene chain may be a hydroxyl group as it is or may be substituted with other functional groups, etc.

The alkylene oxide group-containing reactive monomers may be used singly or in the form of a mixture of two or more of them, and the content of the reactive monomer as a whole is preferably 20% by weight or less, more preferably 10% by weight or less, furthermore preferably 5% by weight or less, still furthermore preferably 4% by weight or less, particularly preferably 3% by weight or less, and even more preferably 1% by weight or less in the monomer components constituting the (meth)acryl-based polymer. If the content of the alkylene oxide group-containing reactive monomer exceeds 10% by weight, the interaction with the ionic compound becomes significant to inhibit ion conduction and to lower the antistatic property, and thus it is not preferable.

In the present invention, the oxyalkylene unit of the alkylene oxide group-containing reactive monomer may be one having an alkylene group of 1 to 6 carbon atoms, such as an oxymethylene group, an oxyethylene group, an oxypropylene group, or an oxybutylene group. The hydrocarbon group of the oxyalkylene chain may be a straight or branched chain

The alkylene oxide group-containing reactive monomer is more preferably a reactive monomer containing an ethylene oxide group. The use of a (meth)acryl-based polymer containing the reactive monomer containing an ethylene oxide group as a base polymer improves the compatibility with the ionic compound, and preferably suppresses bleeding to an adherend, and gives a pressure-sensitive adhesive composition with less-staining properties.

In the present invention, the alkylene oxide group-containing reactive monomer is typically an alkylene oxide adduct of (meth)acrylic acid or a reactive surfactant having a reactive substituent such as an acryloyl group, a methacryloyl group, or an allyl group in the molecule.

Specific examples of the (meth)acrylic acid alkylene oxide adduct include polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxypolyethylene glycol (meth)acrylate, ethoxypolyethylene glycol (meth)acrylate, butoxypolyethylene glycol (meth)acrylate, octoxypolyethylene glycol (meth)acrylate, lauryloxypolyethylene glycol (meth)acrylate, stearoxypolyethylene glycol (meth)acrylate, phenoxypolyethylene glycol (meth)acrylate, methoxypolypropylene glycol (meth)acrylate, and octoxypolyethylene glycol-polypropylene glycol (meth)acrylate.

Specific examples thereof include, for example, an anion type reactive surfactant, a nonion type reactive surfactant, and a cation type reactive surfactant, having a (meth)acryloyl group, or an allyl group.

The (meth)acryl-based polymer has a weight average molecular weight of 100,000 to 5,000,000, preferably 200,000 to 4,000,000, and more preferably 300,000 to 3,000,000. In the case where the weight average molecular weight is lower than 100,000, adhesive residues tend to be generated owing to lowered cohesive force of the pressure-sensitive adhesive composition. On the other hand, in the case where the weight average molecular weight exceeds 5,000,000, the fluidity of the polymer is lowered, and wettability to a polarizing plate tends to be insufficient, which may tend to cause blisters between the polarizing plate and the pressure-sensitive adhesive composition layer of the pressure-sensitive adhesive sheet. The weight average molecular weight refers to a value measured by GPC (gel permeation chromatography).

The glass transition temperature (Tg) of the (meth)acryl-based polymer is preferably 0° C. or lower, more preferably −10° C. or lower (usually −100° C. or higher). If the glass transition temperature is higher than 0° C., the polymer does not easily flow and wettability on a polarizing plate becomes insufficient, and thus causing blister generated between a polarizing plate and a pressure-sensitive adhesive composition layer of a pressure-sensitive adhesive sheet. In particular, when the glass transition temperature is adjusted to −61° C. or lower, it becomes easy to obtain a pressure-sensitive adhesive composition which is excellent in wettability to a polarizing plate, and light peelability. The glass transition temperature of the (meth)acryl-based polymer can be adjusted within the above range by appropriately varying the monomer component to be used and the composition ratio.

The production of the (meth)acryl-based polymer is not particularly limited, but for example, a known polymerization method including solution polymerization, emulsion polymerization, bulk polymerization, and suspension polymerization. The solution polymerization is more preferred in view of the workability and specific aspects such as low staining to an object to be protected. The resultant polymer may be any one selected from a random copolymer, a block copolymer, an alternate copolymer, a graft copolymer and others.

### <Ionic Compound>

In the pressure-sensitive adhesive sheet of the present invention, the pressure-sensitive adhesive composition preferably contains an ionic compound. Examples of the ionic compound include alkali metal salts and/or ionic liquids. The addition of these ionic compounds gives excellent antistatic properties.

The alkali metal salts have high ionic dissociation, and therefore the salts are preferable in terms of exerting excellent antistatic performance even if the addition amount is very small. The alkali metal salts to be preferably used are metal salts each composed of cations such as Li⁺, Na⁺, and K⁺ and anions such as Cl⁻, Br⁻, I⁻, AlCl₄⁻, Al₂Cl₇⁻, BF₄⁻, PF₆⁻, SCN⁻, ClO₄⁻, NO₃⁻, CH₃COO⁻, C₉H₁₉COO⁻, CF₃COO⁻, C₃F₇COO⁻, CH₃SO₃⁻, CF₃SO₃⁻, C₄F₉SO₃⁻, C₂H₅OSO₃⁻, C₆H₁₃OSO₃⁻, C₈H₁₇OSO₃⁻, (CF₃SO₂)₂N⁻, (C₂F₅SO₂)₂N⁻, (C₃F₇SO₂)₂N⁻, (C₄F₉SO₂)₂N⁻, (CF₃SO₂)₃C⁻, AsF₆⁻, SbF₆⁻, NbF₆⁻, TaF₆⁻, F(HF)ₙ⁻, (CN)₂N⁻, (CF₃SO₂)(CF₃CO)N⁻, (CH₃)₂PO₄⁻, (C₂H₅)₂PO₄⁻, CH₃(OC₂H₄)₂OSO₃⁻, C₆H₄(CH₃)SO₃⁻, (C₂F₅)₃PF₃⁻, CH₃CH(OH)COO⁻, and (FSO₂)₂N⁻. More preferably, lithium salts such as LiBr, Lil, LiBF₄, LiPF₆, LiSCN, LiClO₄, LiCF₃SO₃, Li(CF₃SO₂)₂N, Li(C₂F₅SO₂)₂N, Li(FSO₂)₂N, and Li(CF₃SO₂)₃C are used, and still more preferably, LiCF₃SO₃, Li(CF₃SO₂)₂N, Li(C₂F₅SO₂)₂N, Li(C₃F₇SO₂)₂N, Li(C₄F₉SO₂)₂N, Li(FSO₂)₂N, and Li(CF₃SO₂)₃C are used. These alkali metal salts may be used singly or in the form of a mixture of two or more of them.

Further, the use of the ionic liquid as an antistatic agent can give a pressure-sensitive adhesive layer with a high antistatic effect without deteriorating the adhesive properties. The reason that the use of an ionic liquid gives excellent antistatic properties is not clear in detail; however since an ionic liquid has a low melting point (melting point of 100° C. or lower) as compared with a conventional ionic compound, it is considered that the molecular motion is easy caused and excellent antistatic properties can be obtained. In particular, in the case of preventing electrification for an adherend, it is considered that a very small amount of an ionic liquid is transferred to the adherend to give excellent peeling antistatic properties to the adherend. In particular, since an ionic liquid having a melting point of room temperature (25° C.) or lower is more efficiently transferred to an adherend, excellent antistatic properties are obtained.

Since an ionic liquid is in a liquid state at 100° C. or lower, addition to and either dispersion or dissolution in a pressure-sensitive adhesive can be easily carried out as compared with a solid salt. In addition, since an ionic liquid has no vapor pressure (non-volatility), the liquid is not lost over time and has characteristics of continuously providing the antistatic properties. The “ionic liquid” refers to a molten salt (ionic compound) in a liquid state and having a melting point of 100° C. or lower.

The ionic liquid to be preferably used is composed of organic cation components represented by the following general formulas (A) to (E) and an anion component.

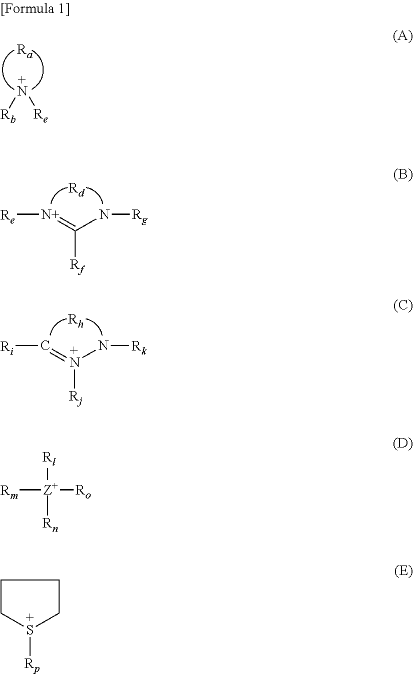

In the formula (A), Rₐ represents a hydrocarbon group of a carbon number of 4 to 20, and may contain a hetero atom, and R_{b} and R_{c} are the same or different, represent hydrogen or a hydrocarbon group of a carbon number of 1 to 16, and may contain a hetero atom, provided that, when a nitrogen atom contains a double bond, R_{c} is not present.

In the formula (B), R_{d} represents a hydrocarbon group of a carbon number of 2 to 20, and may contain a hetero atom, and Rₑ, R_{f} and R_{g} are the same or different, represent hydrogen or a hydrocarbon group of a carbon number of 1 to 16, and may contain a hetero atom.

In the formula (C), Rₕ represents a hydrocarbon group of a carbon number of 2 to 20, and may contain a hetero atom, and Rᵢ, Rⱼ and Rₖ are the same or different, represent a hydrogen or a hydrocarbon group of a carbon number of 1 to 16, and may contain a hetero atom.

In the formula (D), Z represents a nitrogen atom, a sulfur atom, or a phosphorus atom, and Rₗ, Rₘ, Rₙ and Rₒ are the same or different, represent a hydrocarbon group of a carbon number of 1 to 20, and may contain a hetero atom, provided that, when Z is a sulfur atom, Rₒ is not present.

R_{P} in the formula (E) represents a hydrocarbon group of 1 to 18 carbon atoms and may be a functional group in which a part of the hydrocarbon group is substituted with a hetero atom.

Examples of the cation represented by the formula (A) include a pyridinium cation, a piperidinium cation, a pyrrolidinium cation, a cation having a pyrroline skeleton, a cation having a pyrrole skeleton, and a morpholinium cation.

Specific examples thereof include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a pyrrolidinium-2-on cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, a N-ethyl-N-methylmorphonium cation and the like.

Examples of the cation represented by the formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1-(2-methoxyethyl)-3-methylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, a 1,2,3,4-tetramethyl-1,6-dihydropyrimidinium cation and the like.

Examples of the cation represented by the formula (C) include a pyrazolium cation, and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, and a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation represented by the formula (D) include a tetraalkylammonium cation, a trialkylsulfonium cation, a tetraalkylphosphonium cation, and those cations in which a part of the alkyl group is substituted with an alkenyl group, an alkoxyl group, or an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, a trimethyldecylammonium cation, a N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a dimethyldecylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, a trimethyldecylphosphonium cation, a diallyldimethylammonium cation, and a tributyl(2-methoxyethyl)phosphonium cation. Among them, preferably used are asymmetric tetraalkylammonium cations such as a triethylmethylammonium cation, a tributylethylammonium cation, a trimethyldecylammonium cation, a diethylmethylsulfonium cation, a dibutylethylsulfonium cation, a dimethyldecylsulfonium cation, a triethylmethylphosphonium cation, a tributylethylphosphonium cation, and a trimethyldecylphosphonium; and a trialkylsulfonium cation, a tetraalkylphosphonium cation, a N,N-diethyl-N-methyl-N-(2-methoxyethyl)ammonium cation, a glycidyltrimethylammonium cation, a diallyldimethylammonium cation, a N,N-dimethyl-N-ethyl-N-propylammonium cation, a N,N-dimethyl-N-ethyl-N-butylammonium cation, a N,N-dimethyl-N-ethyl-N-pentylammonium cation, a N,N-dimethyl-N-ethyl-N-hexylammonium cation, a N,N-dimethyl-N-ethyl-N-heptylammonium cation, a N,N-dimethyl-N-ethyl-N-nonylammonium cation, a N,N-dimethyl-N,N-dipropylammonium cation, a N,N-diethyl-N-propyl-N-butylammonium cation, a N,N-dimethyl-N-propyl-N-pentylammonium cation, a N,N-dimethyl-N-propyl-N-hexylammonium cation, a N,N-dimethyl-N-propyl-N-heptylammonium cation, a N,N-dimethyl-N-butyl-N-hexylammonium cation, a N,N-diethyl-N-butyl-N-heptylammonium cation, a N,N-dimethyl-N-pentyl-N-hexylammonium cation, a N,N-dimethyl-N,N-dihexylammonium cation, a trimethylheptylammonium cation, a N,N-diethyl-N-methyl-N-propylammonium cation, a N,N-diethyl-N-methyl-N-pentylammonium cation, a N,N-diethyl-N-methyl-N-heptylammonium cation, a N,N-diethyl-N-propyl-N-pentylammonium cation, a triethylpropylammonium cation, atriethylpentylammonium cation, a triethylheptylammonium cation, a N,N-dipropyl-N-methyl-N-ethylammonium cation, a N,N-dipropyl-N-methyl-N-pentylammonium cation, a N,N-dipropyl-N-butyl-N-hexylammonium cation, a N,N-dipropyl-N,N-dihexylammonium cation, a N,N-dibutyl-N-methyl-N-pentylammonium cation, a N,N-dibutyl-N-methyl-N-hexylammonium cation, a trioctylmethylammonium cation, and a N-methyl-N-ethyl-N-propyl-N-pentylammonium cation.

The cation represented by the formula (E) includes, for example, a sulfonium cation. Specific examples of Rp in the formula (E) include a methyl group, an ethyl group, a propyl group, a butyl group, a hexyl group, an octyl group, a nonyl group, a decyl group, a dodecyl group, a tridecyl group, a tetradecyl group, an octadecyl group and the like.

On the other hand, an anion component is not particularly limited as long as the anion component is satisfactory to give an ionic liquid, and examples to be used include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, C₄F₉SO₃⁻, (CF₃SO₂)₂N⁻, (C₂F₅SO₂)₂N⁻, (C₃F₇SO₂)₂N⁻, (C₄F₉SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₃H₇COO⁻, (CF₃SO₂)(CF₃CO)N⁻, C₉H₁₉COO⁻, (CH₃)₂PO₄⁻, (C₂H₅)₂PO₄⁻, C₂H₅OSO₃⁻, C₆H₁₃OSO₃⁻, C₈H₁₇OSO₃⁻, CH₃(OC₂H₄)₂OSO₃⁻, C₆H₄(CH₃)SO₃⁻, (C₂F₅)₃PF₃—, CH₃CH(OH)COO⁻, and (FSO₂)₂N⁻.

It is also possible to use, as an anion component, an anion represented by the following formula (F).

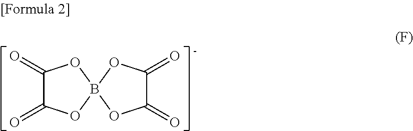

An anion component having a fluorine atom is particularly preferably used as the anion component since an ionic liquid having a low melting point can be obtained.

Specific examples of the ionic liquid to be used in the present invention are those properly selected from combinations of the cation components and the anion components, and include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindoletetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 2-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium trifluoromethanesulfonate, tetrapentylammonium bis(trifluoromethanesulfonyl)imide, tetrahexylammonium trifluoromethanesulfonate, tetrahexylammonium bis(trifluoromethanesulfonyl)imide, tetraheptylammonium trifluoromethanesulfonate, tetraheptylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, tetraoctylphosphonium trifluoromethanesulfonate, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium(trifluoromethanesulfonyl)trifluoroacetamide, 1-butyl-3-methyl pyridinium(trifluoromethanesulfonyl)trifluoroacetamide, 1-ethyl-3-methylimidazolium (trifluoromethanesulfonyl)trifluoroacetamide, N-ethyl-N-methylmorpholinium thiocyanate, 4-ethyl-4-methylmorpholinium methylcarbonate.

As the aforementioned ionic liquid, a commercially available ionic liquid may be used, or the liquid may be synthesized as described below. A method of synthesizing an ionic liquid is not particularly limited as far as an objective ionic liquid is obtained. Generally, a halide method, a hydroxide method, an acid ester method, a chelate forming method, and a neutralization method described in the publication “Ionic liquid—The Front and Future of Development—” (published by CMC) are used.

Regarding a halide method, a hydroxide method, an acid ester method, a chelate forming method, and a neutralization method, a synthesis method using an example of a nitrogen-containing onium salt will be shown below, but other ionic liquid such as a sulfur-containing onium salt, and a phosphorus-containing onium salt can be obtained by the similar procedure.

The halide method is a method which is performed by a reaction shown in the following formulas (1) to (3). First, a tertiary amine and alkyl halide are reacted to obtain halide (Reaction Equation (1), as a halogen, chlorine, bromine or iodine is used). The resulting halide is reacted with an acid (HA) having an anion structure (A⁻) of an objective ionic liquid or a salt (MA, M is a cation forming a salt with an objective anion such as ammonium, lithium, sodium and potassium) of an objective ionic liquid to obtain an objective ionic liquid (R₄NA).

[Formula 3]

R₃N+RX→R₄NX (X: Cl, Br, I) (1)

R₄NX+HA→R₄NA+HX (2)

R₄NX+MA→R₄NA+MX (M: NH₄, Li, Na, K, Ag etc.) (3)

The hydroxide method is a method performed by a reaction shown in (4) to (8). First, a halide (R₄NX) is subjected to ion exchange membrane method electrolysis (reaction equation (4)), an OH-type ion exchange resin method (reaction equation (5)) or a reaction with silver oxide (Ag₂O) (reaction equation (6)) to obtain a hydroxide (R₄NOH) (as a halogen, chlorine, bromine or iodine is used). The resulting hydroxide is subjected to a reaction of reaction equations (7) to (8) as in the aforementioned halide method to obtain an objective ionic liquid (R₄NA).

[Formula 4]

R₄NX+H₂O→R₄NOH+½H₂+½X₂ (X: Cl, Br, I) (4)

R₄NX+P—OH→R₄NOH+P—X (P—OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag etc.) (8)

The acid ester method is a method performed by a reaction shown in (9) to (11). First, tertiary amine (R₃N) is reacted with acid ester to obtain an acid esterified substance (reaction equation (9), as acid ester, ester of an inorganic acid such as sulfuric acid, sulfurous acid, phosphoric acid, phosphorous acid, and carbonic acid, or ester of organic acid such as methanesulfonic acid, methylphosphonic acid and formic acid is used). The resulting acid esterified substance is subjected to a reaction of reaction equations (10) to (11) as in the aforementioned halide method, to obtain an objective ionic liquid (R₄NA). Alternatively, as acid ester, methyl trifluoromethane sulfonate, or methyl trifluoroacetate may be used to directly obtain an ionic liquid.

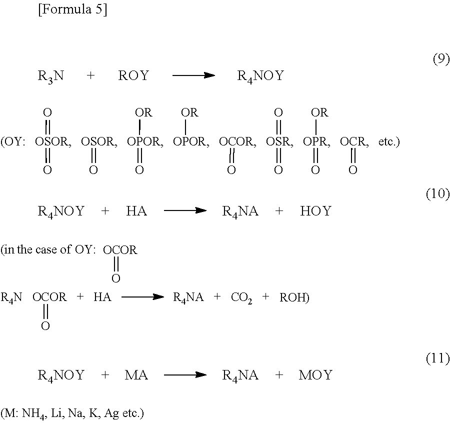

The chelate forming method is a method performed by a reaction as shown in (12) to (15). First, halide of quaternary ammonium (R₄NX), hydroxide of quaternary ammonium (R₄NOH), or carbonic acid esterified substance of quaternary ammonium (R₄NOCO₂CH₃) is reacted with hydrogen fluoride (HF) or ammonium fluoride (NH₄F) to obtain a quaternary ammonium fluoride salt (reaction equation (12) to (14)). The resulting quaternary ammonium fluoride salt can be subjected to a chelate forming reaction with fluoride such as BF₃, AlF₃, PF₅, AsF₅, SbF₅, NbF₅ and TaF₆, to obtain an ionic liquid (reaction equation (15)).

[Formula 6]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (15)

### (MFₙ₋₁: BF₃, AlF₃, PF₅, AsF₅, SbF₅, NbF₅, TaF₅ etc.)

The neutralization method is a method performed by a reaction shown in (16). An ionic liquid can be obtained by reacting tertiary amine and an organic acid such as HBF₄, HPF₆, CH₃COOH, CF₃COOH, CF₃SO₃H, (CF₃SO₂)₂NH, (CF₃SO₂)₃CH, and (C₂F₅SO₂)₂NH.

[Formula 7]

R₃N+HZ→R₃HN⁺Z⁻ (16)

[HZ: HBF₄, HPF₆, CH₃COOH, CF₃COOH, CF₃SO₃H, (CF₃SO₂)₂NH, (CF₃SO₂)₃CH, (C₂F₅SO₂)₂NH organic acid such as]

The aforementioned R in (1) to (16) represents hydrogen or a hydrocarbon group of a carbon number of 1 to 20, and a part of the hydrocarbon group may be functional group substituted with a hetero atom.

The ionic liquids may be used singly or in the form of a mixture of two or more of them.

The content of the ionic compound is preferably 1 part by weight or less, more preferably 0.001 to 0.9 parts by weight, furthermore preferably 0.005 to 0.8 parts by weight, and even more preferably 0.01 to 0.5 parts by weight based on 100 parts by weight of the (meth)acryl-based polymer. If the content falls within the range, both the antistatic properties and the less-staining properties are easily satisfied, and therefore it is preferable.

### <Organopolyoxysiloxane Having Oxyalkylene Chain>

In the pressure-sensitive adhesive sheet of the present invention, the pressure-sensitive adhesive composition preferably contains an organopolysiloxane having an oxyalkylene chain, and more preferably an organopolysiloxane having an oxyalkylene main chain. It is supposed that the use of the organopolysiloxane can lower the surface free energy of the pressure-sensitive surface, and can attain light peelability.

The organopolysiloxane to be used properly in the present invention is a publicly-known organopolysiloxane having a polyoxyalkylene main chain, and is preferably an organopolysiloxane represented by the following formula:

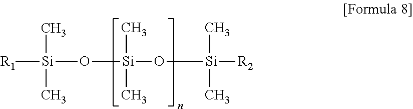

wherein R₁ and/or R₂ have/has an oxyalkylene chain having 1 to 6 carbon atoms; an alkylene group in the oxyalkylene chain may be straight or branched; the oxyalkylene chain may have an alkoxy group or a hydroxyl group at the terminal; either R₁ or R₂ may be a hydroxyl group or an alkyl or alkoxy group; the alkyl group and the alkoxy group may be functional groups which are partially substituted with a hetero atom; and n is an integer of 1 to 300.

The organopolysiloxane to be used is an organopolysiloxane in which a moiety containing siloxane (siloxane moiety) is a main chain and an oxyalkylene chain is bonded to the terminal of the main chain. It is supposed that the use of the organosiloxane having an oxyalkylene chain makes it possible to keep balance of compatibility between the (meth) acryl-based polymer and the ionic compound and attain light peelability.

The organopolysiloxane that can be used in the present invention are those with the following constitution. Specifically, R₁ and/or R₂ in the formula have/has an oxyalkylene chain containing a hydrocarbon group having 1 to 6 carbon atoms, and examples of the oxyalkylene chain include an oxymethylene group, an oxyethylene group, an oxypropylene group, and an oxybutylene group. In particular, an oxyethylene group and an oxypropylene group are preferable. When both of R₁ and R₂ have an oxyalkylene chain, they may be the same or different.

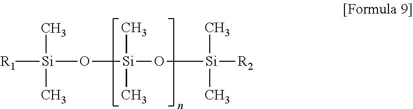

The hydrocarbon group of the oxyalkylene chain may be a straight or branched chain.

The terminal of the oxyalkylene chain may be either an alkoxy group or a hydroxyl group, and in particular, an alkoxy group is more preferred. In the case where a separator is bonded to the pressure-sensitive adhesive layer surface for the purpose of protecting the pressure-sensitive adhesive surface, an organopolysiloxane containing a hydroxyl group at the terminal may cause interaction with the separator to increase the adhesive strength (peel strength) at the time of peeling off the separator from the pressure-sensitive adhesive layer surface.

n is an integer of 1 to 300 and is preferably from 10 to 200, and more preferably from 20 to 150. If n is within the above range, balanced compatibility with a base polymer is achieved, resulting in preferred aspect. It is also possible to have a reactive substituent such as a (meth)acryloyl group, an allyl group or a hydroxyl group in the molecule. The organopolysiloxane may be used alone or in a mixture of two or more.

Specific examples of the organopolysiloxane having the oxyalkylene chain include commercially available products such as X-22-4952, X-22-4272, X-22-6266, KF-6004 and KF-889 (all manufactured by Shin-Etsu Chemical Co., Ltd.); BY16-201 and SF8427 (all manufactured by Dow Corning Toray Co., Ltd.); and IM22 (all manufactured by Wacker Asahikasei Silicone Co., Ltd.). These compounds may be used alone or in a mixture of two or more.

It is also possible to use an organosiloxane having an oxyalkylene chain (organosiloxane to which oxyalkylene chain is bonded) at a side chain other than the organosiloxane having an oxyalkylene chain (organosiloxane to which oxyalkylene chain is bonded) as a main chain, and the use of the organosiloxane having an oxyalkylene chain at a side chain rather than that having an oxyalkylene chain in a main chain is a more preferable embodiment. A publicly-known polyorganosiloxane having a polyoxyalkylene side chain may be used properly as the organopolysiloxane, and a polyorganosiloxane represented by the following formula are preferable.

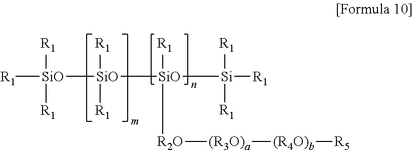

wherein R₁ is a monovalent organic group; R₂, R₃ and R₄ are each an alkylene group; R₅ is a hydrogen or an organic group; m and n are each an integer of 0 to 1000, provided that m and n are not simultaneously 0; a and b are each an integer of 0 to 100, provided that a and b are not simultaneously 0.

The organopolysiloxane that can be used in the present invention are those with the following constitution. Specifically, R₁ in the above formula is a monovalent organic group, e.g., an alkyl group such as a methyl group, an ethyl group, or a propyl group; an aryl group such as a phenyl group or a tolyl group; or an aralkyl group such as a benzyl group or a phenethyl group, all of which may respectively have a substituent group such as a hydroxyl group. R₂, R₃, and R₄ each may be an alkylene group of 1 to 8 carbon atoms such as a methylene group, an ethylene group, or a propylene group. Herein, R₃ and R₄ are each a different alkylene group and R₂ may be the same as or different from R₃ or R₄. Either R₃ or R₄ is preferably an ethylene group or a propylene group in order to increase the concentration of anionic compound soluble in the polyoxyalkylene side chain. R₅ may be a monovalent organic group, e.g., an alkyl group such as a methyl group, an ethyl group, or a propyl group; or an acyl group such as an acetyl group or a propionyl group, all of which may respectively have a substituent group such as a hydroxyl group. These compounds may be used singly or in the form of a mixture of two or more of them. These compounds may have a reactive substituent group such as a (meth) acryloyl group, an allyl group, or a hydroxyl group in the molecule. The organosiloxane having a polyoxyalkylene side chain containing a hydroxyl group at the terminal is preferable among the organosiloxanes having a polyoxyalkylene side chain since it is supposed that the compatibility can be easily balanced.

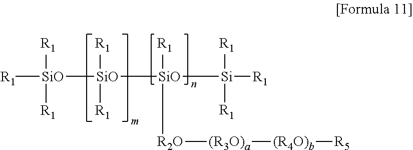

Specific examples of the organosiloxane as commercially available products include trade names KF-351A, KF-352A, KF-353, KF-354L, KF-355A, KF-615A, KF-945, KF-640, KF-642, KF-643, KF-6022, X-22-6191, X-22-4515, KF-6011, KF-6012, KF-6015, KF-6017, and X-22-2516 (all manufactured by Shin-Etsu Chemical Co., Ltd.); SF8428, FZ-2162, SH3749, FZ-77, L-7001, FZ-2104, FZ-2110, L-7002, FZ-2122, FZ-2164, FZ-2203, FZ-7001, SH8400, SH8700, SF8410, and SF8422 (all manufactured by Dow Corning Toray Co., Ltd.); TSF-4440, TSF-4441, TSF-4445, TSF-4450, TSF-4446, TSF-4452, TSF-4460 (manufactured by Momentive Performance Materials Inc.); and BYK-333, BYK-307, BYK-377, BYK-UV3500, and BYK-UV3570 (manufactured by BYK Japan KK). These compounds may be used singly or in the form of a mixture of two or more of them.

The organosiloxane to be used in the present invention has a HLB (Hydrophile-Lipophile Balance) value of preferably 1 to 16, and more preferably 3 to 14. If the HLB value is out of the range, the staining properties to the adherend are worsened, and thus it is not preferable.

The content of the organopolysiloxane is preferably 0.01 to 5 parts by weight, more preferably 0.03 to 3 parts by weight, furthermore preferably 0.05 to 1 part by weight, and even more preferably 0.05 to 0.5 parts by weight based on 100 parts by weight of the (meth)acryl-based polymer. If the content falls within the range, both the antistatic properties and the light peelability (removability) are easily satisfied, and therefore it is preferable.

### <Crosslinking Agent>

In the pressure-sensitive adhesive sheet of the present invention, the pressure-sensitive adhesive composition preferably contains a crosslinking agent. In the present invention, the pressure-sensitive adhesive composition is used for forming a pressure-sensitive adhesive layer. The constituent unit and component ratio of the (meth)acryl-based polymer, the selection and addition ratio of the crosslinking agent, and the like are appropriate controlled for crosslinking, to thereby obtain a pressure-sensitive adhesive sheet (pressure-sensitive adhesive layer) with more excellent heat resistance.

The crosslinking agent to be used in the present invention may be an isocyanate compound, an epoxy compound, a melamine-based resin, an aziridine derivative, a metal chelate compound, etc., and particularly, the use of an isocyanate compound is a preferable embodiment. These compounds may be used singly or in the form of a mixture of two or more of them.

Examples of the isocyanate compound include aliphatic polyisocyanates such as trimethylene diisocyanate, butylene diisocyanate, hexamethylenediisocyanate (HDI), and dimer acid diisocyanate; alicyclic isocyanates such as cyclopentylene diisocyanate, cyclohexylene diisocyanate, and isophorone diisocyanate (IPDI); aromatic isocyanates such as 2,4-tolylene diisocyanate, 4,4′-diphenylmethanediisocyanate, and xylylene diisocyanate (XDI); and modified polyisocyanates obtained by modifying the isocyanate compounds with allophanate bonding, biuret bonding, isocyanurate bonding, uretdione bonding, urea bonding, carbodiimide bonding, uretonimine bonding, oxadiazinetrione bonding, etc. Examples thereof as commercially available products include trade names TAKENATE 300S, TAKENATE 500, TAKENATE D165N, and TAKENATE D178N (all manufactured by Takeda Pharmaceutical Co., Ltd.), Sumidur T80, Sumidur L, and Desmodur N3400 (all manufactured by Sumitomo Bayer Urethane Co., Ltd.); and Millionate MR, Millionate MT, Coronate L, Coronate HL, and Coronate HX (all manufactured by Nippon Polyurethane Industry Co., Ltd.). These isocyanate compounds may be used singly or in the form of a mixture of two or more of them, and it is also possible to use a bifunctional isocyanate compound and a trifunctional isocyanate compound in combination. The combination use of the crosslinking agents makes it possible to satisfy both adherability and repulsion resistance (adhesion to a curved surface) and to obtain a pressure-sensitive adhesive sheet more excellent in adhesion reliability.

In the case of using a bifunctional isocyanate compound and a trifunctional isocyanate compound in combination as the isocyanato compound, the mixing ratio (weight ratio) of the two compounds: [bifunctional isocyanate compound]/[trifunctional isocyanate compound](weight ratio) is preferably 0.1/99.9 to 50/50, more preferably 0.1/99.9 to 20/80, furthermore preferably 0.1/99.9 to 10/90, more preferably 0.1/99.9 to 5/95, and even more preferably 0.1/99.9 to 1/99. Mixing the two compounds at a ratio within the range is a preferable embodiment since the mixing gives a pressure-sensitive adhesive composition excellent in adherability and repulsion resistance.

Examples of the epoxy compound include N,N,N′,N′-tetraglycidyl-m-xylenediamine (trade name TETRAD-X manufactured by Mitsubishi Gas Chemical Company, Inc.) and 1,3-bis(N,N-diglycidylaminomethyl)cyclohexane (trade name TETRAD-C manufactured by Mitsubishi Gas Chemical Company Inc.).

Examples of the melamine-based resin include hexamethylolmelamine. Examples of the aziridine derivative as commercially available products include trade names HDU, TAZM, and TAZO (all manufactured by Sogo Pharmaceutical Co., Ltd.).

Metal chelate compounds include a metal component such as aluminum, iron, tin, titanium, or nickel, and a chelate component such as acetylene, methyl acetoacetate, or ethyl lactate.

The content of the crosslinking agent to be used in the present invention is preferably 0.01 to 10 parts by weight, more preferably 0.1 to 8 parts by weight, furthermore preferably 0.5 to 5 parts by weight, and even more preferably 1.0 to 2.5 parts by weight based on 100 parts by weight of the (meth) acryl-based polymer. If the content is less than 0.01 parts by weight, the crosslinking agent may insufficiently form crosslinking, so that the cohesive force of the pressure-sensitive adhesive composition may be low, which may result in obtaining insufficient heat resistance or tends to cause adhesive residues. On the other hand, if the content exceeds 10 parts by weight, the pressure-sensitive adhesive composition may have high cohesive force to reduce fluidity, so that the wettability to a polarizing plate may be insufficient, which tends to cause blisters between the polarizing plate and the pressure-sensitive adhesive layer (pressure-sensitive adhesive composition layer). In addition, the crosslinking agent in a large amount tends to lower the peeling antistatic properties. These crosslinking agents may be used singly or in the form of a mixture of two or more of them.

The pressure-sensitive adhesive composition may further contain a crosslinking catalyst for more effectively promoting any of the above-mentioned crosslinking reactions. Examples of the crosslinking catalyst that can be used include tin-based catalysts such as dibutyltin dilaurate and dioctyltin dilaurate; and iron-based catalysts such as tris(acetylacetonato)iron, tris(hexane-2,4-dionato)iron, tris(heptane-2,4-dionato)iron, tris(heptane-3,5-dionato)iron, tris(5-methylhexane-2,4-dionato)iron, tris(octane-2,4-dionato)iron, tris(6-methylheptane-2,4-dionato)iron, tris(2,6-dimethylheptane-3,5-dionato)iron, tris(nonane-2,4-dionato)iron, tris(nonane-4,6-dionato)iron, tris(2,2,6,6-tetramethylheptane-3,5-dionato)iron, tris(tridecane-6,8-dionato)iron, tris(1-phenylbutane-1,3-dionato)iron, tris(hexafluoroacetylacetonato)iron, tris(acetoacetic acid ethyl ester)iron, tris(acetoacetic acid n-propyl ester)iron, tris(acetoacetic acid isopropyl ester)iron, tris(acetoacetic acid n-butyl ester)iron, tris(acetoacetic acid sec-butyl ester)iron, tris(acetoacetic acid tert-butyl ester)iron, tris(propionylacetic acid methyl ester)iron, tris(propionylacetic acid ethyl ester)iron, tris(propionylacetic acid n-propyl ester)iron, tris(propionylacetic acid isopropyl ester)iron, tris(propionylacetic acid n-butyl ester)iron, tris(propionylacetic acid sec-butyl ester)iron, tris(propionylacetic acid tert-butyl ester)iron, tris(acetoacetic acid benzyl ester)iron, tris(malonic acid dimethyl ester)iron, tris(malonic acid diethyl ester)iron, trimethoxyiron, triethoxyiron, tri-isopropoxyiron, and ferric chloride. These crosslinking catalysts may be used singly or in combination of two or more of them.

The content (use amount) of the crosslinking catalyst is not particularly limited, but for example, the content is preferably 0.0001 to 1 part by weight and more preferably 0.001 to 0.5 parts by weight based on 100 parts by weight of the (meth)acryl-based polymer. If the content falls within the range, the crosslinking reaction speed is high at the time of forming the pressure-sensitive adhesive layer, and the pot life of the pressure-sensitive adhesive composition is prolonged, and therefore it is a preferable embodiment.

The pressure-sensitive adhesive composition of the present invention may contain a polyoxyalkylene chain-containing compound containing no organopolysiloxane. The addition of the compound to the pressure-sensitive adhesive composition can provide a pressure-sensitive adhesive composition with more excellent wettability to an adherend.

Specific examples of the polyoxyalkylene chain-containing compound containing no organopolysiloxane include nonionic surfactants such as polyoxyalkylenealkylamine, polyoxyalkylenediamine, polyoxyalkylene fatty acid ester, polyoxyalkylenesorbitan fatty acid ester, polyoxyalkylene alkyl phenyl ether, polyoxyalkylene alkyl ether, polyoxyalkylene alkyl allyl ether and polyoxyalkylene alkyl phenyl allyl ether; anionic surfactants such as polyoxyalkylene alkyl ether sulfuric acid ester, polyoxyalkylene alkyl ether phosphoric acid ester salt, polyoxyalkylene alkyl phenyl ether sulfuric acid ester salt and polyoxyalkylene alkyl phenyl ether phosphoric acid ester salt; cationic surfactants and amphoteric surfactants, having a polyoxyalkylene chain (polyalkyleneoxide chain); polyether compound having a polyoxyalkylene chain (including derivatives thereof), acryl compounds having a polyoxyalkylene chain (including derivatives thereof); and the like. Further, a polyoxyalkylene chain-containing monomer may be added as the polyoxyalkylene chain-containing compound to an acryl-based polymer. These polyoxyalkylene chain-containing compounds may be used singly or in combination of two or more of them.

Specific examples of the polyether compound having a polyoxyalkylene chain include a polypropylene glycol (PPG)-polyethylene glycol (PEG) block copolymer, a PPG-PEG-PPG block copolymer, and a PEG-PPG-PEG block copolymer. Examples of the polyether compound derivative having a polyoxyalkylene chain include a terminal-etherified oxypropylene group-containing compound (PPG monoalkyl ether, PEG-PPG monoalkyl ether, etc.) and a terminal-acetylated oxypropylene group-containing compound (terminal-acetylated PPG, etc.).

Specific examples of the acrylic compound having a polyoxyalkylene chain include a (meth)acrylate polymer containing an oxyalkylene group. The addition mole number of an oxyalkylene unit as the oxyalkylene group is preferably 1 to 50, more preferably 2 to 30, and furthermore preferably 2 to 20 in terms of coordination of the ionic compound. The terminal of the oxyalkylene chain may be a hydroxyl group as it is or substituted with an alkyl group, a phenyl group, etc.

The (meth)acrylate polymer containing an oxyalkylene group is preferably a polymer containing (meth)acrylic acid alkylene oxide as a monomer unit (component), and specific examples of the (meth) acrylic acid alkylene oxide, as ethylene glycol group-containing (meth)acrylate, include methoxy-polyethylene glycol (meth)acrylate type such as methoxy-diethylene glycol (meth)acrylate and methoxy-triethylene glycol (meth)acrylate; ethoxy-polyethylene glycol (meth)acrylate type such as ethoxy-diethyleneglycol (meth)acrylate and ethoxy-triethylene glycol (meth)acrylate; butoxy-polyethylene glycol (meth)acrylate type such as butoxy-diethylene glycol (meth)acrylate and butoxy-triethylene glycol (meth)acrylate; phenoxy-polyethylene glycol (meth)acrylate type such as phenoxy-diethylene glycol (meth)acrylate and phenoxy-triethylene glycol (meth)acrylate; 2-ethylhexyl-polyethylene glycol (meth)acrylate; nonylphenol-polyethylene glycol (meth)acrylate type; and methoxy-polypropylene glycol (meth)acrylate type such as methoxydipropylene glycol (meth)acrylate.

Other monomer units (components) other than the (meth)acrylic acid alkylene oxide may be used as the monomer unit (component). Specific examples of the other monomer components include acrylates and/or methacrylates each containing an alkyl group of 1 to 14 carbon atoms such as methyl (meth)acrylate, ethyl (meth)acrylate, n-butyl (meth)acrylate, sec-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate.

Further, it is also possible to properly use a carboxyl group-containing (meth)acrylate, a phosphoric acid group-containing (meth)acrylate, a cyano group-containing (meth)acrylate, vinyl esters, an aromatic vinyl compound, an acid anhydride group-containing (meth)acrylate, a hydroxyl group-containing (meth)acrylate, an amide group-containing (meth)acrylate, an amino group-containing (meth)acrylate, an epoxy group-containing (meth)acrylate, N-acryloylmorpholine, and vinyl ethers as the other monomer units (components) other than the (meth)acrylic acid alkylene oxide.

In a preferred embodiment, the polyoxyalkylene chain-containing compound containing no organopolysiloxane is a compound which has a (poly)ethylene oxide chain at least in a portion. The addition of the (poly)ethylene oxide chain-containing compound improves compatibility between the base polymer and the antistatic component, and preferably suppresses bleeding to an adherend, and thus gives a pressure-sensitive adhesive composition with less-staining properties. In particular, in the case of using a PPG-PEG-PPG block copolymer, a pressure-sensitive adhesive composition with excellent less-staining properties is obtained. In the polyethylene oxide chain-containing compound, the weight ratio of the (poly)ethylene oxide chain to the total weight of the polyoxyalkylene chain-containing compound containing no organopolysiloxane is preferably 5 to 90% by weight, more preferably 5 to 85% by weight, furthermore preferably 5 to 80% by weight, and even more preferably 5 to 75% by weight.

The polyoxyalkylene chain-containing compound containing no organopolysiloxane has a number average molecular weight (Mn) of suitably 50,000 or less, preferably 200 to 3,0000, and more preferably 200 to 10,000, but usually, one having a number average molecular weight of 200 to 5,000 is preferably used. If Mn is too much higher than 50,000, compatibility with the acryl-based polymer tends to be lowered, which results in whitening of the pressure-sensitive adhesive layer. If Mn is too much less than 200, staining with the polyoxyalkylene compound may be likely to occur. Herein, Mn refers to a value in terms of polystyrene measured by GPC (gel permeation chromatography).

Specific examples of the polyoxyalkylene chain-containing compound containing no organopolysiloxane as commercially available products include ADEKA Pluronic 17R-4 and ADEKA Pluronic 25R-2 (both manufactured by ADEKA CORPORATION); and Emulgen 120 (manufactured by KAO Corporation).

The addition amount of the polyoxyalkylene chain-containing compound containing no organopolysiloxane can be set to, for example, 0.005 to 20 parts by weight, preferably 0.01 to 10 parts by weight, more preferably 0.05 to 5 parts by weight, and even more preferably 0.1 to 1 part by weight based on 100 parts by weight of the acryl-based polymer. If the addition amount is too small, the effect of preventing bleeding of the antistatic component may be lowered, and on the other hand, if the addition amount is too large, staining with the polyoxyalkylene compound may be likely to occur.

### <Acrylic Oligomer>

The pressure-sensitive adhesive composition may further contain an acrylic oligomer. The acrylic oligomer has a weight average molecular weight of preferably 1,000 or more and less than 30,000, more preferably 1,500 or more and less than 20,000, and furthermore preferably 2,000 or more and less than 10,000. The acrylic oligomer is a (meth) acryl-based polymer containing, as a monomer unit, a (meth)acryl-based monomer having an alicyclic structure represented by the following formula (1), and in the case of using the acrylic oligomer as a removable acrylic pressure-sensitive adhesive composition in this embodiment, the acrylic oligomer functions as a tackifier resin, improves adhesion (adherability), and is effective for suppressing floating of the pressure-sensitive adhesive sheet.

CH₂═C(R¹)COOR² (1)

wherein, R¹ is a hydrogen atom or a methyl group; and R² is an alicyclic hydrocarbon group having an alicyclic structure.

Examples of the alicyclic hydrocarbon group R² in the formula (1) may include alicyclic hydrocarbon groups such as a cyclohexyl group, an isobornyl group, and a dicyclopentanyl group. Examples of a (meth) acrylic acid ester containing such an alicyclic hydrocarbon group include esters of (meth) acrylic acid and aliphatic alcohol such as cyclohexyl (meth)acrylate containing a cyclohexyl group, isobornyl (meth)acrylate containing an isobornyl group, and dicyclopentanyl (meth)acrylate containing a dicyclopentanyl group. When the acrylic oligomer contains such an acryl-based monomer having a relatively bulky structure as the monomer unit, the adhesion can be improved.

In this embodiment, the alicyclic hydrocarbon group constituting the acrylic oligomer is preferable to have a bridged ring structure. The bridged ring structure refers to a tricyclic or higher alicyclic structure. The acrylic oligomer is provided with a bulkier structure like a bridged ring structure, and thereby the adhesion of a removable acrylic pressure-sensitive adhesive composition (removable acrylic pressure-sensitive adhesive sheet) can be further improved.

Examples of R², which is an alicyclic hydrocarbon group containing a bridged ring structure, may include a dicyclopentanyl group represented by the following formula (3a), a dicyclopentenyl group represented by the following formula (3b), an adamantyl group represented by the following formula (3c), a tricyclopentanyl group represented by the following formula (3d), and a tricyclopentenyl group represented by the following formula (3e). In the case where UV polymerization is employed at the time of synthesizing an acrylic oligomer or producing a pressure-sensitive adhesive composition, in terms of hardly inhibiting polymerization, particularly (meth)acryl-based monomers having a saturated structure such as a cyclopentanyl group represented by the following formula (3a), an adamantyl group represented by the following formula (3c), and a tricyclopentanyl group represented by the following formula (3d) are preferably used as the monomer constituting the acrylic oligomer among the (meth)acryl-based monomers having a tricyclic or higher alicyclic structure containing a bridged ring structure.

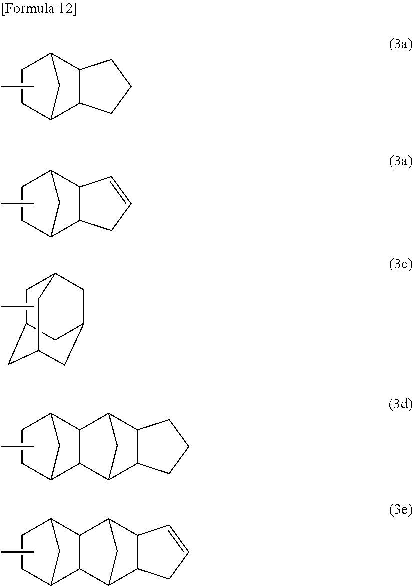

Examples of the (meth)acryl-based monomer having a tricyclic or higher alicyclic structure containing a bridged ring structure include (meth)acrylic acid esters such as dicyclopentanyl methacrylate, dicyclopentanyl acrylate, dicyclopentanyl oxyethyl methacrylate, dicyclopentanyl oxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. These (meth) acryl-based monomers may be used singly or in combination of two or more of them.

The acrylic oligomer in this embodiment may be a homopolymer of a (meth) acryl-based monomer having an alicyclic structure, or a copolymer of a (meth) acryl-based monomer having an alicyclic structure with another (meth)acrylic acid ester monomer or with a copolymerizable monomer.

Examples of the (meth)acrylic acid ester monomer may include (meth)acrylic acid alkyl esters such as methyl (meth)acrylate, ethyl (meth)acrylate, propyl (meth)acrylate, isopropyl (meth)acrylate, butyl (meth)acrylate, isobutyl (meth)acrylate, sec-butyl(meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, and dodecyl (meth)acrylate;

(meth)acrylic acid aryl esters such as phenyl (meth)acrylate and benzyl (meth)acrylate; and

(meth)acrylic acid esters derived from terpene compound derivative alcohols. These (meth)acrylic acid esters may be used singly or in combination of two or more of them.

The acrylic oligomer may be also obtained by copolymerization of other monomer component (copolymerizable monomer) copolymerizable with a (meth) acrylic acid ester other than the (meth)acrylic acid ester component unit.

Examples of the other monomer copolymerizable with a (meth) acrylic acid ester may include carboxyl group-containing monomers such as acrylic acid, methacrylic acid, carboxyethyl acrylate, carboxypentyl acrylate, itaconic acid, maleic acid, fumaric acid, crotonic acid, and isocrotonic acid;

alkoxyalkyl (meth)acrylate-based monomers such as methoxyethyl (meth)acrylate, ethoxyethyl (meth)acrylate, propoxyethyl (meth)acrylate, butoxyethyl (meth)acrylate, and ethoxypropyl (meth)acrylate;

salts such as (meth)acrylic acid alkali metal salts;

di(meth)acrylic acid ester monomers of (poly)alkylene glycol such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol, di(meth)acrylic acid ester of propylene glycol, di(meth)acrylic acid ester of dipropyleneglycol, and di(meth)acrylic acid ester of tripropylene glycol;

poly(meth)acrylic acid ester monomers such as trimethylolpropane tri(meth)acrylic acid ester;

vinyl esters such as vinyl acetate and vinyl propionate;

halogenated vinyl compounds such as vinylidene chloride and 2-chloroethyl (meth)acrylate;

oxazolinyl group-containing polymerizable compounds such as 2-vinyl-2-oxazoline, 2-vinyl-5-methyl-2-oxazoline, and 2-isopropenyl-2-oxazoline;

aziridine group-containing polymerizable compounds such as (meth)acryloylaziridine and 2-aziridinylethyl (meth)acrylate;

epoxy group-containing vinyl monomers such as allyl glycidyl ether, (meth)acrylic acid glycidyl, and (meth) acrylic ethylglycidyl ether;

hydroxyl group-containing vinyl monomers such as 2-hydroxyethyl (meth)acrylate, 2-hydroxypropyl (meth)acrylate, and adducts of lactones and 2-hydroxyethyl(meth)acrylate;

macromonomers obtained by bonding an unsaturated group such as a (meth) acryloyl group, a styryl group, or a vinyl group to the terminal of a polyalkylene glycol such as polypropylene glycol, polyethylene glycol, polytetramethylene glycol, polybutylene glycol, a copolymer of polyethylene glycol and polypropylene glycol, or a copolymer of polybutylene glycol and polyethylene glycol;

fluorine-containing vinyl monomers such as fluorine-substituted (meth)acrylic acid alkyl ester;

acid anhydride group-containing monomers such as maleic anhydride and itaconic anhydride;

aromatic vinyl compounds such as styrene, α-methylstyrene, and vinyltoluene;

reactive halogen-containing vinyl monomers such as 2-chloroethyl vinyl ether and vinyl monochloroacetate;

amide group-containing vinyl monomers such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloylmorpholine;

succinimide-based monomers such as N-(meth)acryloyloxymethylenesuccinimide, N-(meth)acryloyl-6-oxyhexamethylenesuccinimide, and N-(meth)acryloyl-8-oxyoctamethylenesuccinimide;

maleimide-based monomers such as N-cyclohexylmaleimide, N-isopropylmaleimide, N-laurylmaleimide, and N-phenylmaleimide;

itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide;

nitrogen-containing heterocyclic monomers such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinylpyrazole, N-vinylisoxazole, N-vinylthiazole, N-vinylisothiazole, and N-vinylpyridazine;

N-vinylcarboxylic acid amides;

lactam-based monomers such as N-vinylcaprolactam;

cyanoacrylate monomers such as (meth)acrylonitrile;

aminoalkyl (meth)acrylate-based monomers such as aminoethyl (meth)acrylate, N,N-dimethylaminoethyl (meth)acrylate, N,N-dimethylaminoethyl (meth)acrylate, and tert-butylaminoethyl (meth)acrylate;

imide group-containing monomers such as cyclohexylmaleimide and isopropylmaleimide;

isocyanate group-containing monomers such as 2-isocyanatoethyl (meth)acrylate;

organosilicon-containing vinyl monomers such as vinyltrimethoxysilane, γ-methacryloxypropyltrimethoxysilane, allyltrimethoxysilane, trimethoxysilylpropylallylamine, and 2-methoxyethoxytrimethoxysilane;

hydroxyl group-containing monomers, e.g., hydroxyalkyl (meth)acrylates such as hydroxyethyl (meth)acrylate, hydroxypropyl (meth)acrylate, hydroxybutyl (meth)acrylate, hydroxyhexyl (meth)acrylate, hydroxyoctyl (meth)acrylate, hydroxydecyl (meth)acrylate, hydroxylauryl (meth)acrylate, and (4-hydroxymethylcyclohexyl)methyl methacrylate;

acrylic acid ester-based monomers having a heterocycle, a halogen atom, a silicon atom or the like such as tetrahydrofurfuryl (meth)acrylate, fluorine atom-containing (meth)acrylate, and silicone (meth)acrylate;

olefin-based monomers such as isoprene, butadiene, and isobutylene;

vinyl ether-based monomers such as methyl vinyl ether and ethyl vinyl ether;

olefins or dienes such as ethylene, butadiene, isoprene, and isobutylene;

vinyl ethers such as vinyl alkyl ether;

vinyl chloride; and

macromonomers having a radically polymerizable vinyl group at the monomer end to which a vinyl group has been polymerized. These monomers may be polymerized alone or copolymerized in combination with the (meth)acrylic acid ester.

Examples of the acrylic oligomer may include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of methyl methacrylate (MMA) and isobornyl methacrylate (IBXMA), a copolymer of cyclohexyl methacrylate (CHMA) and acryloylmorpholine (ACMO),

a copolymer of cyclohexyl methacrylate (CHMA) and diethylacrylamide (DEAA),
a copolymer of 1-adamantyl acrylate (ADA) and methyl methacrylate (MMA), a copolymer of dicyclopentanyl methacrylate (DCPMA) and isobornyl methacrylate (IBXMA), a copolymer of dicyclopentanyl methacrylate (DCPMA) and methyl methacrylate (MMA), a copolymer of dicyclopentanyl methacrylate (DCPMA) and N-vinyl-2-pyrrolidone (NVP), a copolymer of dicyclopentanyl methacrylate (DCPMA) and hydroxyethyl methacrylate (HEMA), a copolymer of dicyclopentanyl methacrylate (DCPMA) and acrylic acid (AA), and homopolymers of dicyclopentanyl methacrylate (DCPMA), cyclohexyl methacrylate (CHMA), isobornyl methacrylate (IBXMA), isobornyl acrylate (IBXA), dicyclopentanyl acrylate (DCPA), 1-adamantyl methacrylate (ADMA), 1-adamantyl acrylate (ADA), and methyl methacrylate (MMA).

Further, a functional group having reactivity with an epoxy group or an isocyanate group may be introduced into the acrylic oligomer. Examples of the functional group may include a hydroxyl group, a carboxyl group, an amino group, an amide group, and a mercapto group, and a monomer having such a functional group may be used (copolymerized) at the time of producing the acrylic oligomer.

In the case the above-mentioned acrylic oligomer is a copolymer of a (meth)acryl-based monomer having an alicyclic structure with another (meth) acrylic acid ester monomer or with a copolymerizable monomer, the content of the (meth)acryl-based monomer having an alicyclic structure is preferably 5% by weight or more, more preferably 10% by weight or more, furthermore preferably 20% by weight or more, and even more preferably 30% by weight or more (usually less than 100% by weight and preferably 90% by weight or less) in all monomers constituting the acrylic oligomer. If the content of the (meth)acryl-based monomer having an alicyclic structure is 5% by weight or more, the adhesion can be improved without lowering the transparency.

The acrylic oligomer has a weight average molecular weight of 1,000 or more and less than 30,000, preferably 1,500 or more and less than 20,000, and more preferably 2,000 or more and less than 10,000. If the weight average molecular weight is more than 30,000, the adhesion is lowered. On the other hand, if the weight average molecular weight is less than 1,000, because of low molecular weight, it results in lowering of the adhesive strength of the pressure-sensitive adhesive sheet.

The addition amount of the acrylic oligomer is preferably 0.01 to 10 parts by weight, more preferably 0.1 to 7 parts by weight, furthermore preferably 0.2 to 5 parts by weight, and even more preferably 0.3 to 2 parts by weight based on 100 parts by weight of the (meth)acryl-based polymer. The use of the acrylic oligomer in the above-mentioned range improves the adhesive strength to an adherend, and easily suppresses blistering, and thus it is a preferable embodiment.

Further, the pressure-sensitive adhesive composition to be used for the pressure-sensitive adhesive sheet of the present invention may contain other publicly-known additives, and for example, a powder such as a coloring agent or a pigment, a surfactant, a plasticizer, a tackifier, a low molecular weight polymer, a surface lubricant, a leveling agent, an antioxidant, a corrosion preventing agent, a photostabilizer, an ultraviolet absorbing agent, a polymerization inhibitor, a silane coupling agent, an inorganic or organic filler, a metal powder, granules, foils and others may be properly added depending on use.

### <Pressure-Sensitive Adhesive Layer and Pressure-Sensitive Adhesive Sheet>

The pressure-sensitive adhesive sheet of the present invention is obtained by forming the pressure-sensitive adhesive layer on a supporting film, and at this time, crosslinking of the pressure-sensitive adhesive composition is generally carried out after application of the pressure-sensitive adhesive composition, but it is also possible to transfer the pressure-sensitive adhesive layer containing the pressure-sensitive adhesive composition after crosslinking to a supporting film or the like.

A method for forming the pressure-sensitive adhesive layer on a supporting film may be any appropriate method, but for example, the pressure-sensitive adhesive composition is applied to a supporting film and the polymerization solvent or the like is dried out and removed to form the pressure-sensitive adhesive layer on the supporting film. Thereafter, the pressure-sensitive adhesive layer may be cured for the purpose of adjusting migration of the components of the pressure-sensitive adhesive layer and adjusting the crosslinking reaction. Further, in the case of producing the pressure-sensitive adhesive sheet by applying the pressure-sensitive adhesive composition (solution) to the supporting film, one or more kinds of solvents other than the polymerization solvent may be newly added to the pressure-sensitive adhesive composition in order to evenly apply the composition onto the supporting film.

At the time of producing the pressure-sensitive adhesive sheet of the present invention, publicly-known methods employed for producing pressure-sensitive adhesive tapes are used to form the pressure-sensitive adhesive layer. Specific examples include roll coating, gravure coating, reverse coating, roll blush, spray coating, air knife coating, and extrusion coating using a die coater.

The pressure-sensitive adhesive sheet of the present invention is formed in such a manner that the pressure-sensitive adhesive layer has a thickness of 3 to 100 μm, and preferably about 5 to 50 μm. If the thickness of the pressure-sensitive adhesive layer falls within the range, good balance between the removability and the adhesion can be obtained, and therefore it is preferable. The pressure-sensitive adhesive sheet is obtained by forming the pressure-sensitive adhesive layer, through application, on one surface of various supporting films made of plastic films such as polyester films and porous materials such as paper and nonwoven fabrics, and the resultant is formed into a sheet-like shape, a tape-like shape, etc.

### <Supporting Film>

The pressure-sensitive adhesive sheet of the present invention has a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, and the supporting film is preferably a plastic film. In the case where the pressure-sensitive adhesive sheet is used as a surface protective film, the supporting film is preferably a plastic film subjected to an antistatic treatment. Owing to the antistatic treatment of the supporting film, electrification of the surface protective film itself is suppressed at the time of peeling, and therefore it is preferable. Since the pressure-sensitive adhesive sheet includes a pressure-sensitive adhesive layer (using an antistatic agent, etc.) formed by crosslinking a pressure-sensitive adhesive composition having such action, electrification of an object to be protected which is not prevented from electrification at the time of peeling is prevented, and the sheet is obtained as a surface protective film with lessened staining on an object to be protected. For this reason, the pressure-sensitive adhesive sheet is very useful as a surface protective film in technical fields related to optical and electronic components where electrification and staining are particularly serious problems. When the supporting film is a plastic film and the plastic film is subjected to an antistatic treatment, one which suppresses electrification of the surface protective film itself and is excellent in antistatic properties for an object to be protected can be obtained.

The supporting film (substrate) is more preferably a plastic film having heat resistance and solvent resistance, as well as flexibility. When the supporting film has flexibility, the pressure-sensitive adhesive composition can be applied using a roll coater or the like, and the resultant can be wound into a roll.

The plastic film is not particularly limited as far as it can be formed into a sheet or a film, and examples include a polyolefin film such as polyethylene, polypropylene, poly-1-butene, poly-4-methyl-1-pentene, an ethylene.propylene copolymer, an ethylene.1-butene copolymer, an ethylene.vinyl acetate copolymer, an ethylene.ethyl acrylate copolymer, and an ethylene.vinyl alcohol copolymer, a polyester film such as polyethylene terephthalate, polyethylene naphthalate, and polybutylene terephthalate, a polyacrylate film, a polystyrene film, a polyamide film such as nylon 6, nylon 6,6, and partially aromatic polyamide, a polyvinyl chloride film, a polyvinylidene chloride film, and a polycarbonate film.

The supporting film has a thickness of usually 5 to 200 μm and preferably about 10 to 100 μm. If the thickness of the supporting film falls within the range, the workability of bonding the film to an adherend and the workability of peeling the film from the adherend are excellent, and therefore, it is preferable.

The supporting film may be subjected to an easy adhesion treatment such as an acid treatment, an alkali treatment, a primer treatment, a corona treatment, a plasma treatment, or an ultraviolet ray treatment, or to an application type, kneading type, or vapor deposition type antistatic treatment, if necessary.

The antistatic treatment is not particularly limited, and a method of forming an antistatic layer on at least one surface of a general-purpose supporting film (substrate), or a method of kneading a kneading-based antistatic agent into a plastic film may be employed. Examples of a method of forming the antistatic layer on at least one surface of the supporting film include a method of application of an antistatic resin containing an antistatic agent and a resin component, or an electroconductive resin containing an electroconductive polymer and an electroconductive substance; and a method of performing vapor deposition or plating of an electroconductive substance.

Examples of an electrification preventing agent contained in an electrification preventing resin include a cation type electrification preventing agent having a cationic functional group such as a quaternary ammonium salt, a pyridinium salt, and a primary, secondary or tertiary amino group, an anion type electrification preventing agent having an anionic functional group such as a sulfonic acid salt, a sulfuric acid ester salt, a phosphonic acid salt, and a phosphoric ester salt, an amphoteric type electrification preventing agent such as alkylbetain and a derivative thereof, imidazoline and a derivative thereof, and alanine and a derivative thereof, a nonion type electrification preventing agent such as glycerin and a derivative thereof, and polyethylene glycol and a derivative thereof, and an ionic electrically conductive polymer obtained by polymerizing or copolymerizing a monomer having the aforementioned cation type, anion type, or amphoteric type ionic electrically conductive group. These compounds may be used alone, or two or more of them may be used by mixing.

Specifically, examples of the cation type electrification preventing agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion type electrification preventing agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric type electrification preventing agent include alkylbetain, alkylimidazoliumbetain, and carbobetaingrafted copolymer. These compounds may be used alone, or two or more kinds may be used by mixing.

Examples of the nonion typeelectrification preventing agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxyethylenesorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the electrically conductive polymer include polyaniline, polypyrrole and polythiophene. These electrically conductive polymers may be used alone, or two or more kinds may be used by mixing.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof. These electrically conductive substances may be used alone, or two or more kinds may be used by mixing.

As a resin component used in the electrification preventing resin and the electrically conductive resin, a generally used resin such as polyester, acryl, polyvinyl, urethane, melanine and epoxy is used. In the case of a polymer-type electrification preventing agent, it is not necessary that a resin component is contained. In addition, the electrification preventing resin component may contain compounds of a methylolated or alkylolated melanine series, a urea series, a glyoxal series, and an acrylamide series, an epoxy compound, or an isocyanate compound as a crosslinking agent.

An electrification preventing layer is formed, for example, by diluting the aforementioned electrification preventing resin, electrically conductive polymer or electrically conductive resin with a solvent such as an organic solvent and water, and coating this coating solution on a plastic film, followed by drying.

Examples of an organic solvent used in formation of the electrification preventing layer include methyl ethyl ketone, acetone, ethyl acetate, tetrahydrofuran, dioxane, cyclohexanone, n-hexane, toluene, xylene, methanol, ethanol, n-propanol and isopropanol. These solvents may be used alone, or two or more kinds may be used by mixing.

As a coating method in formation of the electrification preventing layer, the known coating method is appropriately used, and examples include roll coating, gravure coating, reverse coating, roll brushing, spray coating, and air knife coating methods, an immersing and curtain coating method.

A thickness of the aforementioned electrification preventing resin layer, electrically conductive polymer or electrically conductive resin is usually 0.001 to 5 μm, preferably around 0.03 to 1 μm. Within the above range, the plastic film is less likely to degrade in heat resistance, solvent resistance and flexibility, which is preferred.

Examples of a method of depositing or plating an electrically conductive substance include vacuum deposition, sputtering, ion plating, chemical deposition, spray pyrolysis, chemical plating, and electric plating methods.

The thickness of the electrically-conductive material layer is generally from 0.002 to 1 μm, preferably from 0.005 to 0.5 μm. Within the above range, the plastic film is less likely to degrade in heat resistance, solvent resistance and flexibility, which is preferred.

As the kneading-type antistatic agent, the aforementioned antistatic agent is appropriately used. The amount of the kneading-type antistatic agent to be blended is 20% by weight or less, preferably in a range of 0.05 to 10% by weight, based on the total weight of a plastic film. Within the above range, the plastic film is less likely to degrade in heat resistance, solvent resistance and flexibility, which is preferred. A kneading method is not particularly limited as far as it is a method by which the antistatic agent can be uniformly mixed into a resin used in a plastic film, but for example, a heating roll, a Banbury mixer, a pressure kneader, and a biaxial kneading machine are used.

### <Top Coat Layer>

The pressure-sensitive adhesive sheet of the present invention has a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, characterized in that the top coat layer contains wax as a lubricant and a polyester resin as a binder. When the pressure-sensitive adhesive sheet (surface protective film) has the top coat layer, the pressure-sensitive adhesive sheet is provided with improved scratching resistance, and it is a preferable embodiment.

### <Binder>

The top coat layer contains a polyester resin as a binder and wax as a lubricant. The polyester resin is preferably a resin material containing a polyester as a main component (typically a component in the content of more than 50% by weight, preferably 75% by weight or more, and for example, 90% by weight or more). Typically, the polyester is preferable to have a condensation structure of one or more compounds selected from polyvalent carboxylic acids having 2 or more carboxyl groups in one molecule (typically dicarboxylic acids) and their derivatives (anhydrides, esters, halides, etc. of the polyvalent carboxylic acids) and one or more compounds selected from polyhydric alcohols having 2 or more hydroxyl groups in one molecule (typically diols).

Examples of the compound that can be used as the polyvalent carboxylic acid component include aliphatic dicarboxylic acids such as oxalic acid, malonic acid, difluoromalonic acid, alkylmalonic acid, succinic acid, tetrafluorosuccinic acid, alkylsuccinic acid, (±)-malic acid, meso-tartaric acid, itaconic acid, maleic acid, methylmaleic acid, fumaric acid, methylfumaric acid, acetylene dicarboxylic acid, glutaric acid, hexafluoroglutaric acid, methylglutaric acid, glutaconic acid, adipic acid, dithioadipic acid, methyladipic acid, dimethyladipic acid, tetramethyladipic acid, methylene adipic acid, muconic acid, galactaric acid, pimelic acid, suberic acid, perfluorosuberic acid, 3,3,6,6-tetramethylsuberic acid, azelaic acid, sebacic acid, perfluorosebacic acid, brasylic acid, dodecyldicarboxylic acid, tridecyldicarboxylic acid, and tetradecyldicarboxylic acid; alicyclic dicarboxylic acids such as cycloalkyldicarboxylic acids (e.g., 1,4-cyclohexane dicarboxylic acid, 1,2-cyclohexane dicarboxylic acid), 1,4-(2-norbornene)dicarboxylic acid, 5-norbornene-2,3-dicarboxylic acid (himic acid), adamantanedicarboxylic acid, and spiroheptane dicarboxylic acid; aromatic dicarboxylic acids such as phthalic acid, isophthalic acid, dithioisophthalic acid, methylisophthalic acid, dimethylisophthalic acid, chloroisophthalic acid, dichloroisophthalic acid, terephthalic acid, methylterephthalic acid, dimethylterephthalic acid, chloroterephthalic acid, bromoterephthalic acid, naphthalene dicarboxylic acid, oxofluorene dicarboxylic acid, anthracene dicarboxylic acid, biphenyl dicarboxylic acid, biphenylene dicarboxylic acid, dimethylbiphenylene dicarboxylic acid, 4,4″-p-terephenylene dicarboxylic acid, 4,4″-p-quaterphenyl dicarboxylic acid, bibenzyl dicarboxylic acid, azobenzene dicarboxylic acid, homophthalic acid, phenylene diacetic acid, phenylene dipropionic acid, naphthalene dicarboxylic acid, naphthalene dipropionic acid, biphenyl diacetic acid, biphenyl dipropionic acid, 3,3′-[4,4′-(methylene di-p-biphenylene)dipropionic acid, 4,4′-bibenzyl diacetic acid, 3,3′(4,4′-bibenzyl)dipropionic acid, and oxydi-p-phenylene diacetic acid; acid anhydrides of any of the above-mentioned polyvalent carboxylic acids; esters of any of the above-mentioned polyvalent carboxylic acids (e.g., may be alkyl esters, monoesters and diesters); and acid halides corresponding to any of the above-mentioned polyvalent carboxylic acids (e.g., dicarboxylic acid chloride).

Preferable examples of the compound that can be used as the polyvalent carboxylic acid component include aromatic dicarboxylic acids such as terephthalic acid, isophthalic acid, and naphthalene dicarboxylic acid, and their acid anhydrides; aliphatic dicarboxylic acids such as adipic acid, sebacic acid, azelaic acid, succinic acid, fumaric acid, maleic acid, himic acid, and 1,4-cyclohexane dicarboxylic acid, and their acid anhydrides; and lower alkyl esters of the dicarboxylic acids (e.g., esters with monoalcohols having 1 to 3 carbon atoms).

On the other hand, examples of the compound that can be used as the polyhydric alcohol component include diols such as ethylene glycol, propylene glycol, 1,2-propanediol, 1,3-propanediol, 1,3-butanediol, 1,4-butanediol, neopentyl glycol, 1,5-pentanediol, 1,6-hexanediol, 3-methylpentanediol, diethylene glycol, 1,4-cyclohexane dimethanol, 3-methyl-1,5-pentanediol, 2-methyl-1,3-propanediol, 2,2-diethyl-1,3-propanediol, 2-butyl-2-ethyl-1,3-propanediol, xylene glycol, hydrogenated bisphenol A, and bisphenol A. Other examples thereof include alkylene oxide adducts of these compounds (e.g., ethylene oxide adducts, propylene oxide adducts, etc.).

In a preferable embodiment, the polyester resin contains a water-dispersible polyester (typically, containing the water-dispersible polyester as a main component). Such a water-dispersible polyester can be a polyester with improved water dispersibility by introducing, for example, a hydrophilic functional group (e.g., one or more kinds of hydrophilic functional groups such as sulfonic acid metal salt groups, carboxyl groups, ether groups, and phosphoric acid groups) into a polymer. As a method for introducing a hydrophilic functional group into a polymer, publicly-known methods may be properly employed such as a method for copolymerizing a compound having a hydrophilic functional group; and a method for producing a hydrophilic functional group by modifying a polyester or its precursor (e.g., a polyvalent carboxylic acid component, a polyhydric alcohol component, their oligomers, etc.). One example of preferable water-dispersible polyesters may be a polyester (copolyester) obtained by copolymerization of a compound having a hydrophilic functional group.

In the technique disclosed herein, the polyester resin to be used as a binder for the top coat layer may be one containing a saturated polyester as a main component or one containing an unsaturated polyester as a main component. In one preferable embodiment of the technique disclosed herein, the main component of the polyester resin is a saturated polyester. A polyester resin containing a saturated polyester (e.g., saturated copolyester) provided with water dispersibility as a main component is preferably used. Such a polyester resin (may be one prepared in the form of water dispersion solution) can be synthesized by a publicly-known method or can be easily commercially available.

The polyester resin may have a weight average molecular weight in terms of standard polystyrene of about 5×10³ to 1.5×10⁵ (preferably about 1×10⁴ to 6×10⁴) which is measured by gel permeation chromatography (GPC). The polyester resin may have a glass transition temperature (Tg) of, for example, 0 to 120° C. (preferably 10 to 80° C.).

The top coat layer may further contain a resin (e.g., one or more kinds of resins selected from acrylic resins, acrylic-urethane resins, acrylic-styrene resins, acrylic-silicone resins, silicone resins, polysilazane resins, polyurethane resins, fluoro resins, polyolefin resins, etc.) other than the polyester resin as a binder to an extent that the performances (e.g., transparency, scratching resistance, whitening resistance, etc.) of the pressure-sensitive adhesive sheet (surface protective film) disclosed herein are not largely deteriorated. One preferable embodiment of the technique disclosed herein is a case where the binder of the top coat layer is substantially only composed of a polyester resin. For example, the top coat layer is preferable which has a proportion of the polyester resin of 98 to 100% by weight in the binder. The proportion of the binder in the top coat layer can be set to, for example, 50 to 95% by weight, and is usually adequate to set to 60 to 90% by weight.

### <Lubricant>

The top coat layer in the technique disclosed herein is characterized in that wax is contained as a lubricant, and it is preferable to contain an ester of a higher fatty acid and a higher alcohol (hereinafter, may be referred to as “wax ester”) as the wax. Herein, the “higher fatty acid” refers to a carboxylic acid (typically monovalent carboxylic acid) having 8 or more (typically 10 or more, preferably 10 or more and 40 or less) carbon atoms. On the other hand, the “higher alcohol” refers to an alcohol (typically, monohydric or dihydric alcohol, preferably monohydric alcohol) having 6 or more (typically 10 or more, preferably 10 or more and 40 or less) carbon atoms. The top coat layer with composition containing the wax ester and the binder (polyester resin) in combination is hardly whitened even if the layer is held in high temperature and high humidity conditions. Consequently, a pressure-sensitive adhesive sheet (surface protective film) provided with a supporting film (substrate) having such a top coat layer can have a higher appearance quality.

At the time of carrying out the technique disclosed herein, the reason for attaining more excellent whitening resistance to the top coat layer with the above configuration (e.g., properties of being hardly whitened even if the layer is held in high temperature and high humidity conditions) is not clear, but the following reason is considered as one possibility. That is, a silicone-based lubricant used previously is supposed to exhibit a function of providing slip properties to the surface of the top coat layer by bleeding in the surface. However, the degree of bleeding of the silicone-based lubricant is easily fluctuated depending on the difference of preservation conditions (temperature, humidity, passing of time, etc.). Therefore, in the case of preservation in normal preservation conditions (e.g., 25° C., 50% RH), if the use amount of a silicon-based lubricant is set so as to obtain proper slip properties for a relatively long time (e.g., about 3 months) immediately after the production of a pressure-sensitive adhesive sheet (surface protective film), the bleeding of the lubricant is promoted excessively when the pressure-sensitive adhesive sheet is preserved for 2 weeks in high temperature and high humidity conditions (e.g., 60° C., 95% RH). Accordingly, the silicone-based lubricant excessive bled whitens the top coat layer (subsequently, the pressure-sensitive adhesive sheet).

In the technique disclosed herein, a specified combination of the wax ester as the lubricant and the polyester resin as the binder for the top coat layer is employed. Owing to the combination of the lubricant and the binder, the degree of the bleeding of the wax ester out of the top coat layer is hardly affected by the preservation conditions. Because of that, it is considered the whitening resistance of the pressure-sensitive adhesive sheet (surface protective film) is improved.

One or more kinds of compounds represented by the following formula (2) are preferably used as the wax ester.

X—COO—Y (2)

In the formula (2), X and Y are each independently selected from hydrocarbon groups having 10 to 40 carbon atoms (more preferably 10 to 35, and furthermore preferably 14 to 35, and for example, 20 to 32). If the number of carbon atoms is too small, the effect of imparting the slip properties to the top coat layer may tend to be insufficient. The hydrocarbon group may be saturated or unsaturated. Generally, the hydrocarbon group is preferably a saturated hydrocarbon group. The hydrocarbon group may have a structure containing an aromatic ring or may have a structure containing no aromatic ring (aliphatic hydrocarbon group). Further, the hydrocarbon group may be a hydrocarbon group having a structure containing an aliphatic ring (alicyclic hydrocarbon group) or may be a linear hydrocarbon group (including straight chain and branched chain).

Examples as a preferable wax ester in the technique disclosed herein are compounds represented by the formula (2) in which X and Y each independently are a linear alkyl group (more preferably straight chain alkyl group) having 10 to 40 carbon atoms. Specific examples of the compounds include myricyl cerotate (CH₃(CH₂)₂₄COO(CH₂)₂₉CH₃), myricyl palmitate (CH₃(CH₂)₁₄COO(CH₂)₂₉CH₃), cetyl palmitate (CH₃(CH₂)₁₄COO(CH₂)₁₅CH₃), and stearyl stearate (CH₃(CH₂)₁₆COO(CH₂)₁₇CH₃).

The wax ester has a melting point of preferably 50° C. or higher (more preferably 60° C. or higher, furthermore preferably 70° C. or higher, and for example, 75° C. or higher). The use of the wax ester can attain higher whitening resistance. The wax ester preferably has a melting point of 100° C. or lower. Since the wax ester is highly effective to impart slip properties, it is made possible to form a top coat layer with higher scratching resistance. The fact that the wax ester has a melting point of 100° C. or lower is preferable in terms of easy production of a water dispersion of the wax ester. For example, myricyl cerotate may be preferably used.

A naturally-occurring wax containing the wax ester may be used as a raw material for the top coat layer. One containing more than 50% by weight of the wax ester (in the case where two or more wax esters are contained, their total content) on non-volatile component (NV) basis (more preferably 65% by weight or more, and for example, 75% by weight or more) is preferably used as the naturally-occurring wax. For example, naturally-occurring waxes, e.g., vegetable waxes such as carnauba wax (generally, containing 60% by weight or more, more preferably 70% by weight or more, and typically 80% by weight or more of myricyl cerotate) and palm wax; animal waxes such as beeswax and whale wax; etc, can be used. The naturally-occurring wax to be used has a melting point of, in general, preferably 50° C. or higher (more preferably 60° C. or higher, furthermore preferably 70° C. or higher, and for example, 75° C. or higher). A chemically synthesized wax ester may be used as the raw material for the top coat layer, and one with high purity of the wax ester by refining the naturally-occurring wax may be also used. These raw materials may be used singly or in a proper combination.

The proportion of the lubricant in the entire top coat layer may be set to 5 to 50% by weight, and generally, the proportion is suitably set to 10 to 40% by weight. If the content of the lubricant is too small, the scratching resistance tends to be lowered. If the content of the lubricant is too large, the effect of improving the whitening resistance may tend to be insufficient.

In the technique disclosed herein, an embodiment may be carried out by adding other lubricants in addition to the wax ester to the top coat layer to an extent that the application effect is not largely deteriorated. Examples of the other lubricant include various kinds of wax other than wax esters such as petroleum-based waxes (paraffin wax, etc.), mineral-based waxes (montane wax, etc.), higher fatty acids (cerotic acid, etc.), and neutral fats (palmitic acid triglyceride, etc.). Alternatively, in addition to the wax ester, a common silicone-based lubricant, a fluoro-based lubricant, etc., may be supplementarily added. In the technique disclosed herein, an embodiment may be preferably carried out by adding substantially no silicone-based lubricant, fluoro-based lubricant, etc. (e.g., an embodiment in which the total content of these lubricants in the entire top coat layer is 0.01% by weight or lower or detection limit or lower). However, it does not mean to exclude the addition of a silicone compound to be used for a purpose other than a lubricant (e.g., as a defoaming agent for a coating material for top coat formation described below) to an extent that the application effect of the technique disclosed herein is not largely deteriorated.

The top coat layer in the technique disclosed herein may contain additives such as an antistatic component, a crosslinking agent, an antioxidant, a coloring agent (pigment, dye, etc.), a fluidity adjusting agent (thixotropic agent, thickener, etc.), a film forming aid, a surfactant (defoaming agent, dispersant, etc.), and a preserver, if necessary.

### <Antistatic Component in Top Coat Layer>

In the pressure-sensitive adhesive sheet of the present invention, the top coat layer preferably contains an antistatic component. The antistatic component is a component exhibiting an action of preventing or suppressing electrification of the pressure-sensitive adhesive sheet (surface protective film). In the case where an antistatic component is added to the top coat layer, for example, organic and inorganic electroconductive substances and various antistatic agents may be used as the antistatic component. The antistatic component to be used for the antistatic layer may be also used.

Examples of the organic electroconductive substance include cationic antistatic agents having a cationic functional group such as a quaternary ammonium salt, a pyridinium salt, a primary amino group, a secondary amino group, and a tertiary amino group; anionic antistatic agents containing an anionic functional group such as a sulfonate, a sulfate, a phosphonate, and a phosphate; amphoteric ionic antistatic agents such as alkyl betain and its derivatives, imidazoline and its derivatives, and alanine and its derivatives; nonionic antistatic agents such as aminoalcohol and its derivatives, glycerin and its derivatives, and polyethylene glycol and its derivatives; ionic electroconductive polymers obtained by polymerization or copolymerization of monomers having the cationic, anionic, amphoteric ionic electroconductive groups (e.g., quaternary ammonium group); and electroconductive polymers such as polythiophene, polyaniline, polypyrrole, polyethylene imine, and an allyleamine-based electroconductive polymer. These antistatic agents may be used singly or in combination of two or more of them.

Examples of the inorganic electroconductive substance include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, ITO (indium oxide/tin oxide), and ATO (antimony oxide/tin oxide). These inorganic electroconductive substances may be used singly or in combination of two or more of them.

Examples of the antistatic agent include cationic antistatic agents, anionic antistatic agents, amphoteric ionic antistatic agents, nonionic antistatic agents, and ionic electroconductive polymers obtained by polymerization or copolymerization of monomers having the cationic, anionic, amphoteric ionic electroconductive groups.

In one preferable embodiment, the antistatic component to be used in the top coat layer contains an organic electroconductive substance. Various kinds of electroconductive polymers may be preferably used as the organic electroconductive substance. With such a configuration, it is made easy to satisfy both good antistatic properties and high scratching resistance. Examples of the electroconductive polymer include polythiophene, polyaniline, polypyrrole, polyethylene imine, and an allyleamine-based polymer. These electroconductive polymers may be used singly or in combination of two or more of them. The electroconductive polymers may be used in combination with other antistatic components (inorganic electroconductive substances, antistatic agents, etc.). The use amount of the electroconductive polymer may be set to, for example, 10 to 200 parts by weight, and usually, the use amount is suitably set to 25 to 150 parts by weight (for example, 40 to 120 parts by weight) based on 100 parts by weight of the binder contained in the top coat layer. If the use amount of the electroconductive polymer is too small, the antistatic effect may be lowered. If the use amount of the electroconductive polymer is too large, the compatibility of the electroconductive polymer in the top coat layer tends to be insufficient so that the appearance quality of the top coat layer may be lowered or the solvent resistance may tend to be lowered.

Examples of the electroconductive polymer that can be used preferably in the technique disclosed herein include polythiophene and polyaniline. One having a weight average molecular weight (hereinafter, may be referred to as “Mw”) in term of standard polystyrene of 4×10⁵ or lower is preferable, and one having a weight average molecular weight in term of standard polystyrene of 3×10⁵ or lower is more preferable as the polythiophene. One having an Mw of 5×10⁵ or lower is preferable, and one having an Mw of 3×10⁵ or lower is more preferable as the polyaniline. In general, these electroconductive polymers each have an Mw of preferably 1×10³ or higher, and more preferably 5×10³ or higher. The polythiophene refers to a polymer of unsubstituted or substituted thiophene. One preferable example of the substituted thiophene polymer in the technique disclosed herein is poly(3,4-ethylenedioxythiophene).

In the case where a method for applying a coating material for top coat layer formation to a supporting film (substrate) and drying and curing the coating material is employed as the method for forming the top coat layer, the electroconductive polymer to be used for preparing the coating material is preferably an electroconductive polymer dissolved or dispersed in water (aqueous electroconductive polymer solution). Such an aqueous electroconductive polymer solution can be prepared by, for example, dissolving or dispersing an electroconductive polymer having a hydrophilic functional group (which may be synthesized by a method of copolymerizing a monomer containing a hydrophilic functional group in the molecule, etc.) in water. Examples of the hydrophilic functional group include a sulfo group, an amino group, an amide group, an imino group, a hydroxyl group, a mercapto group, a hydrazino group, a carboxyl group, a quaternary ammonium group, a sulfate group (—O—SO₃H), and a phosphate group (e.g., —O—PO(OH)₂). The hydrophilic functional group may be in a salt form. Examples of an aqueous polythiophene solution as commercialized products include trade name, “Denatron” series manufactured by Nagase ChemteX Corporation. Examples of an aqueous polyanilinesulfonic acid solution as commercialized products include trade name, “aqua-PASS” manufactured by Mitsubishi Rayon Co., Ltd.

In one preferable embodiment of the technique disclosed herein, an aqueous polythiophene solution is used for preparing the coating material. The use of an aqueous polythiophene solution containing polystyrene sulfonate (PSS) (which may be in the state where PSS is added to polythiophene as a dopant) is preferable. The aqueous solution may contain polythiophene and PSS at a weight ratio of polythiophene:PSS of 1:1 to 1:10. The total content of polythiophene and PSS in the aqueous solution may be, for example, about 1 to 5% by weight. Examples of the aqueous polythiophene solution as commercialized products include trade name, “Baytron” manufactured by H. C. Stark. In the case where the aqueous polythiophene solution containing PSS is used as described above, the total amount of polythiophene and PSS may be set to 5 to 200 parts by weight (usually 10 to 100 parts by weight, and for example, 25 to 70 parts by weight) based on 100 parts by weight of the binder.

The top coat layer disclosed herein may contain a electroconductive polymer in combination with one or more kinds of other antistatic components (organic electroconductive substances other than the electroconductive polymer, inorganic electroconductive substances, antistatic agents, etc.), if necessary. In one preferable embodiment, the top coat layer may contain substantially no antistatic component other than the electroconductive polymer. That is, the technique disclosed herein is preferably carried out in an embodiment in which the antistatic component contained in the top coat layer is substantially composed of only an electroconductive polymer.

### <Crosslinking Agent>

In one preferable embodiment of the technique disclosed herein, the top coat layer is preferable to contain a crosslinking agent. Melamine-based, isocyanato-based, and epoxy-based crosslinking agents used for crosslinking for common resins may be properly selected and used as the crosslinking agent. The use of such a crosslinking agent can attain at least one of effects for scratching resistant improvement, solvent resistant improvement, printing fastness improvement, and a decrease in friction coefficient (that is, slip property improvement). In one preferable embodiment, the crosslinking agent includes a melamine-based crosslinking agent. The top coat layer may contain substantially a melamine-based crosslinking agent (melamine-based resin) alone (that is, contains substantially no crosslinking agent other than a melamine-based crosslinking agent) as the crosslinking agent.

### <Formation of Top Coat Layer>

The top coat layer is preferably formed by a method including applying a liquid composition (a coating material for top coat layer formation) obtained by dispersing or dissolving the resin component and additives used according to need in a proper solvent to a supporting film (substrate). For example, a method of applying the coating material to a first surface of a supporting film (substrate) and drying the coating material, and if necessary, carrying out a curing treatment (heat treatment, ultraviolet treatment, etc.) may be preferably employed. The content of NV (non-volatile components) in the coating material may be, for example, 5% by weight or lower (typically 0.05 to 5% by weight), and usually adequate to be 1% by weight of lower (typically 0.10 to 1% by weight). In the case of forming a top coat layer with thin thickness, the content of NV in the coating material is preferably, for example, 0.05 to 0.50% by weight (for example, 0.10 to 0.30% by weight). The use of such a coating material with low NV makes it possible to form a more uniform top coat layer.

Preferably, a solvent constituting the coating material for top coat layer formation can stably dissolve or disperse the component for forming the top coat layer. The solvent may be an organic solvent, water, or a solvent mixture thereof. Those usable as the organic solvent may be one or more kinds of organic solvents selected from esters such as ethyl acetate; ketones such as methyl ethyl ketone, acetone, and cyclohexanone; cyclic ethers such as tetrahydrofuran (THF) and dioxane; aliphatic and alicyclic hydrocarbons such as n-hexane and cyclohexane; aromatic hydrocarbons such as toluene and xylene; aliphatic and alicyclic alcohols such as methanol, ethanol, n-propanol, isopropanol, and cyclohexanol; glycol ethers such as alkylene glycol monoalkyl ethers (e.g., ethylene glycol monomethyl ether, ethylene glycol monoethyl ether) and dialkylene glycol monoalkyl ethers; etc. In one preferable embodiment, the solvent for the coating material is water or a solvent mixture containing water as a main component (e.g., a solvent mixture of water and ethanol).

### <Properties of Top Coat Layer>

The top coat layer in the technique disclosed herein has a thickness of typically 3 to 500 nm (preferably 3 to 100 nm and for example, 3 to 60 nm). If the thickness of the top coat layer is too thick, the transparency (light transmitting property) of the pressure-sensitive adhesive sheet (surface protective film) tends to be lowered. On the other hand, if the thickness of the top coat layer is too thin, it becomes difficult to evenly form the top coat layer (e.g., the thickness unevenness at points becomes significant in the thickness of the top coat layer), and therefore, the appearance of the pressure-sensitive adhesive sheet may tend to be easily uneven.

In one preferable embodiment of the technique disclosed herein, the top coat layer has a thickness of 3 nm or thicker and thinner than 30 nm (e.g., 3 nm or thicker and thinner than 10 nm). A pressure-sensitive adhesive sheet (surface protective film) having such a top coat layer can be excellent in appearance quality. The use of the pressure-sensitive adhesive sheet excellent in appearance quality makes it possible to precisely carry out the appearance inspection of a product (adherend) through the film. The fact that the thickness of the top coat layer is thin is also preferable in terms of few effect on properties (optical properties and dimensional stability) of the supporting film (substrate).

The thickness of the top coat layer can be measured by observing a cross section of the top coat layer with a transmission electron microscope (TEM). For example, regarding a sample of interest (a supporting film on which a top coat layer is formed, a pressure-sensitive adhesive sheet having the supporting film, etc.), a heavy metal dyeing treatment is carried out for the purpose of making the top coat layer clear, the sample is then embedded in a resin and a cross section of the sample obtained by ultrathin section is observed by TEM, so that a result is obtained. The result can be preferably used as the thickness of the top coat layer in the technique disclosed herein. TEM that can be employed is TEM model: “H-7650”, manufactured by Hitachi, Ltd. or the like. In examples described below, the thickness of the top coat layer (average thickness in the viewing field) is actually measured by carrying out a binary treatment for a cross sectional image obtained in the conditions of an acceleration voltage of 100 kV and a magnification of 60,000 times, and thereafter dividing the cross sectional area of the top coat layer by the length of the sample in the viewing field. In the case where the top coat layer can be sufficiently and clearly observed without heavy metal dyeing, the heavy metal dyeing treatment may be omitted. Alternatively, the thickness of the top coat layer may be calculated by producing a calibration curve for the correlation of the thickness measured by TEM and the detection results by various kinds of thickness detection apparatuses (e.g., surface roughness meters, interference thickness meters, infrared spectrometer, various kinds of x-ray diffractometers, etc.) and then carrying out calculation.

In one preferable embodiment of the pressure-sensitive adhesive sheet (surface protective film) disclosed herein, the pressure-sensitive adhesive sheet has a surface resistivity measured in the surface of the top coat layer of 10¹²Ω or lower (typically, 10⁶Ω to 10¹²Ω). The pressure-sensitive adhesive sheet having such surface resistivity is preferably usable as a pressure-sensitive adhesive sheet to be used for processing or conveyance stage for products such as liquid crystal cells and semiconductor devices which should be kept from static electricity. A pressure-sensitive adhesive sheet having a surface resistivity of 10¹¹Ω or lower (typically, 5×10⁶Ω to 10¹¹Ω, and for example, 10⁷Ω to 10¹⁰Ω) is more preferable. The value of the surface resistivity can be calculated from the value of the surface resistance measured in atmosphere of 23° C. and 50% RH by using a commercially available insulation resistance measuring apparatus.

The top coat layer has a friction coefficient of preferably 0.4 or lower. In the case where a load (a load causing scratches) is applied to the top coat layer, the use of the top coat layer with such a low friction coefficient can release the load along the surface of the top coat layer and lessen the friction force caused by the load. Accordingly, the cohesive failure (the damaged state where the top coat layer is fractured in its inside) or the interfacial failure (the damaged state where the top coat layer is peeled from the rear surface of the supporting film) of the top coat layer hardly occurs. Consequently, the phenomenon that scratches are formed in the pressure-sensitive adhesive sheet (surface protective film) can be more preferably prevented. The lower limit of the friction coefficient is not particularly limited, but in consideration of the balance with other properties (appearance quality, printability, etc.), the friction coefficient is usually suitable to be 0.1 or higher (typically, 0.1 or higher and 0.4 or lower), and preferably 0.15 or higher (typically, 0.15 or higher and 0.4 or lower). A value measured by, for example, scratching the surface of the top coat layer with a vertical load of 40 mN in measurement conditions of 23° C. and 50% RH can be employed at the friction coefficient. The use amount of the wax ester (lubricant) may be set so as to attain the above-mentioned preferable friction coefficient. To adjust the friction coefficient, for example, it is also effective to increase the crosslinking density of the top coat layer by adjusting the addition of the crosslinking agent and the film formation conditions.

The pressure-sensitive adhesive sheet (surface protective film) disclosed herein is preferable to have the properties that printing with oily ink (e.g., using an oily marking pen) can be carried out easily on the rear surface (the surface of the top coat layer). The pressure-sensitive adhesive sheet is suitable for writing and displaying the identification number or the like of an adherend (e.g., an optical member), which is an object to be protected, on the pressure-sensitive adhesive sheet in the stage of processing, conveyance or the like of the adherend which is performed while the pressure-sensitive adhesive sheet is bonded to the adherend. Consequently, the pressure-sensitive adhesive sheet also excellent in printability in addition to the appearance quality is preferable. For example, it is preferable that the pressure-sensitive adhesive sheet has high printability with oily ink containing an alcohol-based solvent and a pigment. It is also preferable that the printed ink is hardly erased by smear or transfer deposition (that is, excellent in printing fastness). The pressure-sensitive adhesive sheet disclosed herein is preferable to have solvent resistance to a degree not to cause apparent change in the appearance even if the printing is wiped out with an alcohol (e.g., ethyl alcohol) when the printing is corrected or erased. The degree of the solvent resistance can be measured by, for example, solvent resistance evaluation described below.

Since the top coat layer in the technique disclosed herein contains wax (wax ester) as a lubricant, sufficient slip properties (e.g., preferable friction coefficient described above) can be obtained even in an embodiment in which no further peeling treatment (e.g., treatment by applying a publicly-known releasing agent such as a silicone-based releasing agent or a long chain alkyl-based releasing agent, and drying the releasing agent) is carried out for the surface of the top coat layer. The embodiment in which no further peeling treatment is carried out for the surface of the top coat layer is preferable in terms of prevention of whitening (e.g., whitening due to preservation in heating and humidifying conditions) attributed to the releasing treatment agent. That is also advantageous in terms of solvent resistance.

The pressure-sensitive adhesive sheet (surface protective film) disclosed herein can be an embodiment in which other layers are further formed in addition to the supporting film, the pressure-sensitive adhesive layer, and the top coat layer. Examples of the arrangement of the “other layers” include between a first surface (rear surface) of the supporting film and the top coat layer and between a second surface (front surface) of the supporting film and the pressure-sensitive adhesive layer. The layer arranged between the rear surface of the supporting film and the top coat layer may be, for example, a layer containing an antistatic component (the above-mentioned antistatic layer). The layer arranged between the front surface of the supporting film and the pressure-sensitive adhesive layer may be, for example, an undercoating layer (anchor layer) for increasing the anchor properties of the pressure-sensitive adhesive layer for the second surface, an antistatic layer, etc. The pressure-sensitive adhesive sheet may be a pressure-sensitive adhesive sheet (surface protective film) with a configuration where an antistatic layer is arranged on the front surface of the supporting film, an anchor layer is arranged on the antistatic layer, and a pressure-sensitive adhesive layer is further arranged thereon.

The pressure-sensitive adhesive sheet (surface protective film) of the present invention has a total thickness of preferably 1 to 150 μm, more preferably 3 to 120 μm, and even more preferably 5 to 100 μm. If the total thickness falls within the range, the adhesive properties, workability, and appearance properties can be excellent and it is a preferable embodiment. The total thickness means the total of the thicknesses of all layers including the supporting film, the pressure-sensitive adhesive layer, the top coat layer, and the antistatic layer.

### <Separator>

In the pressure-sensitive adhesive sheet (surface protective film) of the present invention, a separator may be bonded to the pressure-sensitive adhesive layer surface for the purpose of protecting the pressure-sensitive adhesive surface, if necessary.

A material for constituting the separator may be paper or a plastic film, and in terms of excellent surface smoothness, a plastic film is preferably used. The plastic film is not particularly limited as long as the film is a film capable of protecting the pressure-sensitive adhesive layer, and examples include a polyethylene film, a polypropylene film, a polybutene film, a polybutadiene film, a polymethylpentene film, a polyvinyl chloride film, a polyvinyl chloride copolymer film, a polyethylene terephthalate film, a polybutylene terephthalate film, a polyurethane film, and an ethylene-vinyl acetate copolymer film.

The separator has a thickness of usually 5 to 200 μm and preferably about 10 to 100 μm. If the thickness falls within the range, the workability of bonding to the pressure-sensitive adhesive layer and the peeling workability from the pressure-sensitive adhesive layer are excellent, and thus it is preferable. The separator may be subjected to a release and anti-staining treatment by a silicone-based, a fluorine-based, a long chain alkyl-based, or an aliphatic acid amide-based releasing agent and a silica powder; and an application type, a kneading type, or a vapor deposition type antistatic treatment, if necessary.

The pressure-sensitive adhesive sheet of the present invention has a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, wherein an adhesive strength ratio (A/B) of the rear surface adhesive strength (A) at a peel rate of 0.3 m/min after the surface of the top coat layer is bonded at 23° C. for 30 minutes and the adhesive strength (B) at a peel rate of 30 m/min after the pressure-sensitive adhesive surface of the pressure-sensitive adhesive layer is bonded to a TAC surface at 50° C. for 1 week is 3 or higher, preferably 3.5 or higher, and more preferably 4 or higher. If the adhesive strength ratio falls within the range, a preferable embodiment excellent in pick-up properties can be obtained.

The pressure-sensitive adhesive sheet (including the case of a surface protective film) of the present invention has a rear surface adhesive strength (A) of preferably 4.5 N/24 mm or higher, more preferably 5.0 N/24 mm or higher, and furthermore preferably 5.5 N/24 mm or higher. If the adhesive strength is lower than 4.5 N/24 mm, sufficient adhesive strength cannot be obtained, pick-up properties are inferior, and the peeling workability of the protection film is lowered, and therefore, it is not preferable.

The pressure-sensitive adhesive sheet (including the case of a surface protective film) of the present invention has a potential (peeling electrification voltage: kV, absolute value) of the pressure-sensitive adhesive layer generated on the polarizing plate surface of preferably 1.0 kV or lower, more preferably 0.8 kV or lower, and furthermore preferably 0.5 kV or lower when the pressure-sensitive adhesive sheet is peeled off under the conditions of 23° C. and 50% RH, at a peeling angle of 150°, and a peel rate of 30 m/min (high speed peeling). If the peeling electrification voltage exceeds 1.0 kV, for example, a liquid crystal driver or the like may possibly be damaged, and therefore, it is not preferable.

The optical member of the present invention is preferably an optical member which is protected with the pressure-sensitive adhesive sheet. The pressure-sensitive adhesive sheet can prevent an increase in adhesive strength over time, has low adhesive strength at the time of high speed peeling (e.g., 30 m/min), and is excellent in the removability and workability, and thus usable for surface protecting use (surface protective film) at the time of processing, conveyance, shipping, and the like. Accordingly, the pressure-sensitive adhesive sheet is useful for protecting the surface of the optical member (polarizing plate). In the case where the pressure-sensitive adhesive layer constituting the pressure-sensitive adhesive sheet contains an antistatic component, the pressure-sensitive adhesive sheet can be particularly used for plastic products or the like in which static electricity tends to be generated easily, and is thus very useful for preventing electrification in technical fields relating to optical and electronic components where particularly electrification is a serious problem.

### EXAMPLES

Examples and the like which specifically show the configurations and effects of the present invention will be described below. However, the present invention is not limited thereby. Evaluation items in Examples and the like were measured by the following procedures.

### [Evaluation]

The (Meth)acryl-based polymers (polymers), pressure-sensitive adhesive layers (pressure-sensitive adhesive compositions) and pressure-sensitive adhesive sheets obtained in Examples and Comparative Examples were evaluated by the following measurement methods or evaluation methods. The evaluation results of the physical evaluations of the polymers are shown in Table 1; the mixing contents of the pressure-sensitive adhesive compositions are shown in Table 2; and the configurations and evaluation results of the pressure-sensitive adhesive sheets (surface protective films) are shown in Table 3.

### <Measurement of Weight Average Molecular Weight (Mw)>

A weight average molecular weight (Mw) was measured using a GPC apparatus (HLC-8220GPC manufactured by Tosoh Corporation). Measuring conditions are as follows.

Sample concentration: 0.2 wt % (THF solution)

Sample injection amount: 10 μl

Eluent: THF

Flow rate: 0.6 ml/min

Measuring temperature: 40° C.

Column:

Sample column; TSKguard column SuperHZ-H(1 column)+TSK gel Super HZM-H(2 columns)

Reference column; TSK gel SuperH-RC(1 column)

Detector: Refractive index detector (RI)

A molecular weight was obtained in terms of polystyrene.

### <Theoretical Value of Glass Transition Temperature (Tg)>

A glass transition temperature Tg (° C.) was determined by the following equation using the following reference values as a glass transition temperature Tgn (° C.) of a homopolymer of each monomer.

1/(Tg+273)=Σ[Wn/(Tgn+273)] Equation:

[where Tg (° C.) represents a glass transition temperature of a copolymer, Wn (−) represents a weight fraction of each monomer, Tgn (° C.) represents a glass transition temperature of a homopolymer of each monomer, and n represents a kind of each monomer]

### Reference Values:

2-Ethylhexyl acrylate (2EHA): −70° C.

4-Hydroxybutyl acrylate (4HBA): −32° C.

Acrylic acid (AA): 106° C.

Dicyclopentanyl methacrylate (DCPMA): 175° C.

Methyl methacrylate (MMA): 105° C.

“Synthesis and Design of Acrylic Resin and Development of New Applications” (Publishing Department of Chuo Keiei Kaihatsu Center) and “Polymer Handbook” (John Wiley & Sons) were referred for literature values.

### <Measurement of Glass Transition Temperature (Tg)>

A glass transition temperature Tg (° C.) was determined by the method described below using a dynamic viscoelasticity measurement system (ARES manufactured by Rheometric Scientific Inc.).

Sheets of a (meth) acryl-based polymer having a thickness of 20 μm were laminated into a thickness of about 2 mm, and this was punched into φ7.9 mm to prepare a cylindrical pellet, and this was used as a sample for measuring a glass transition temperature.

The measuring sample was fixed on a jig of a φ7.9 mm parallel plate and temperature dependency of loss elastic modulus G″ was measured using the dynamic viscoelasticity measuring apparatus, and a temperature at which the resulting G″ curve became a maximum was adopted as a glass transition temperature (° C.).

Measuring conditions are as follows.

Measurement: shear mode
Temperature range: −70° C. to 150° C.
Temperature raising rate: 5° C./min

### Frequency: 1 Hz

### <Measurement of Thickness of Top Coat Layer>

Each pressure-sensitive adhesive sheet of respective Examples was embedded in a resin after a heavy metal dyeing treatment was carried, and a cross sectional image was obtained by ultrathin section with TEM “H-7650” manufactured by Hitachi Ltd., in the conditions of an acceleration voltage of 100 kV and a magnification of 60,000 times. After the binarization processing of the cross sectional image was carried out, the cross sectional area of the top coat layer was divided by the length of the sample in the viewing field to actually measure the thickness (average thickness in the viewing field) of the top coat layer.

### <Evaluation of Whitening Resistance>

A tester wearing gloves once strongly rubbed the rear surface (the surface of the top coat layer) of each pressure-sensitive adhesive sheet of respective Examples with a polyethylene terephthalate film having a thickness of 38 μm, and whether or not the rubbed part (abraded part) became more transparent than its surrounding (non-abraded part) was observed with eyes. As a result, in the case where the difference of the transparency between the non-abraded part and the abraded part could be confirmed with eyes, it was determined that whitening was caused. If whitening becomes significant, a phenomenon that the contrast between the transparent abraded part and its surrounding (whitened non-abraded part) becomes clearer can be observed.

The observation with eyes was carried out in a dark room (reflection method, transmission method) and in a bright room as follows.

(a) Observation in a dark room by a reflection method: In a room (a dark room) blocked from outside light, a 100 W fluorescent light (product name “Rupicaline” available from Mitsubishi Electric Corporation) was positioned at 100 cm from the rear surface of each pressure-sensitive adhesive sheet of respective Examples, and the rear surface of the sample was observed with eyes from different viewpoints.

(b) Observation in a dark room by a transmission method: In the dark room, the fluorescent light was placed at 10 cm from the front surface (the surface opposite to the surface on which the top coat was formed) of each pressure-sensitive adhesive sheet of respective Examples, and the rear surface of the sample was observed with eyes from different viewpoints.

(c) Observation in a bright room: during daylight hours on a sunny day, the rear surface of the sample was observed with eyes by a window side in a room (a light room) having windows for admission of outside light where it is not exposed to direct sunlight.

The observation results under these three kind conditions were graded into the following five levels.

0: No whitening was observed (both abraded part and non-abraded part were transparent) in all observation conditions.

1: Slight whitening was observed in the dark room observation by the reflection method.

2: Slight whitening was observed in the dark room observation by the transmission method.

3: Slight whitening was observed in the bright room observation.

4: Apparent whitening was observed in the bright room observation.

The whitening resistance evaluation was performed for each pressure-sensitive adhesive sheet in an initial period (kept for 3 days after production in the conditions of 50° C. and 15% RH) and after heating and humidifying (kept for 3 days after production in the conditions of 50° C. and 15% RH and further for 2 weeks in the high temperature and high humidity conditions of 60° C. and 95% RH). In the evaluation after heating and humidifying, the case of 2 or lower grade (0 to 2) in the 5 grade evaluation was determined to be good.

### <Evaluation of Solvent Resistance>

In the dark room, the rear surface (that is, the surface of the top coat layer) of each pressure-sensitive adhesive sheet of respective Examples was wiped with a waste cloth (fabric) wet with ethyl alcohol 5 times and the appearance of the rear surface was observed with eyes. As a result, when no difference of the appearance between the wiped part with ethyl alcohol and the other parts was confirmed with eyes (no appearance change by wiping with ethyl alcohol was observed), it was determined that solvent resistance was good and when wiping unevenness was observed, it was determined that solvent resistance was poor.

### <Measurement of Peeling Electrification Voltage>

After each pressure-sensitive adhesive sheet 1 was cut into a piece in a size of 70 mm in width and 130 mm in length and the separator was peeled off, the piece was press-bonded with a hand roller to the surface (TAC surface) of a polarizing plate 2 (SEG1423DU, TAC polarizing plate manufactured by NITTO DENKO CORPORATION, 70 mm in width and 100 mm in length), which had been previously bonded to an acrylic plate 3 (2 mm in thickness, 70 mm in width, and 100 mm in length) having undergone static elimination in advance, in such a manner that one end of the piece protruded 30 mm out of the plate.

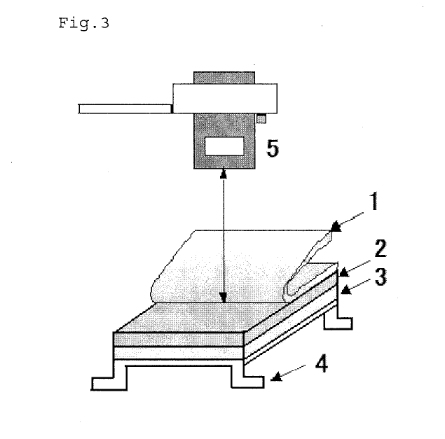

The resulting sample was allowed to stand at 23° C. and 50% RH for one day and then set at a prescribed position as shown in FIG. 3. The one end protruding 30 mm was fixed to an automatic winder, and the piece was peeled off at a peeling angle of 150° and a peel rate of 30 m/min. The potential (peeling electrification voltage: kV, absolute value) generated on the surface of the polarizing plate 2 in this process was measured using a potentiometer 5 (KSD-0103, manufactured by KASUGA ELECTRIC WORKS LTD.) fixed at a position in the center of the polarizing plate 2. The measurement was performed in the environments of 23° C. and 50% RH.

The potential (peeling electrification voltage: kV, absolute value) generated on the surface of the polarizing plate when the pressure-sensitive adhesive layer of the pressure-sensitive adhesive sheet was peeled from the TAC polarizing plate at a peeling angle of 150° and a peel rate of 30 m/min in the conditions of 23° C. and 50% RH is preferably 1.0 kV or lower, more preferably 0.8 kV or lower, and furthermore preferably 0.5 kV or lower. If the peeling electrification voltage exceeds 1.0 kV, for example, a liquid crystal driver or the like may possibly be damaged, and therefore, it is not preferable.

### <Measurement of Rear Surface Adhesive Strength (A)>

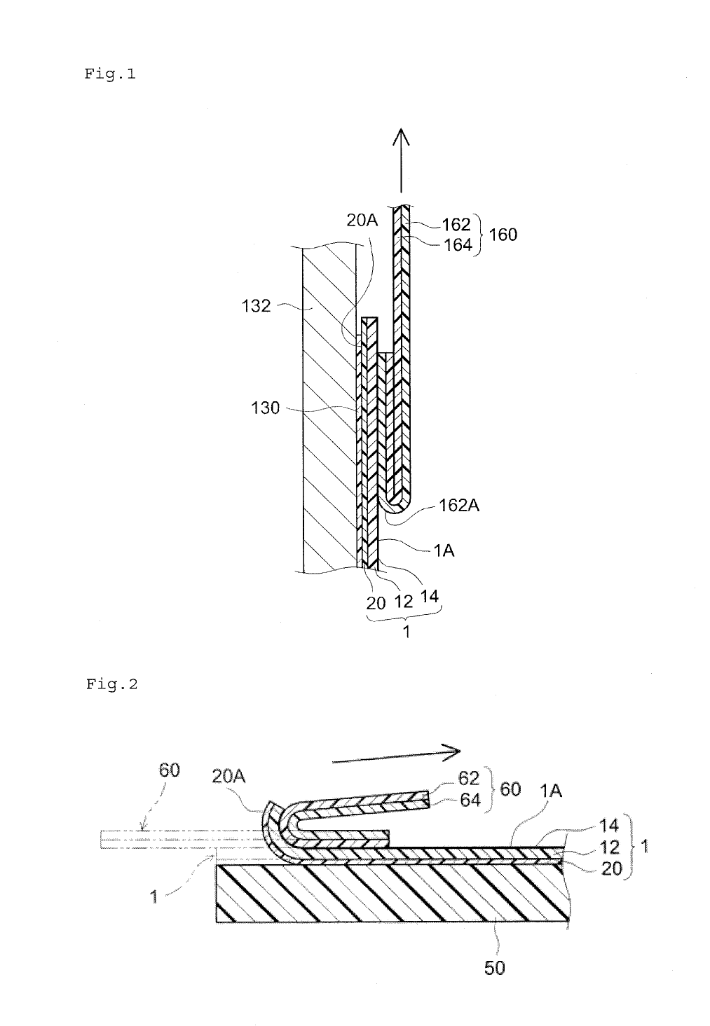

As shown in FIG. 1, each pressure-sensitive adhesive sheet 1 of respective Examples was cut into a piece in a size of 70 mm in width and 100 mm in length, and a pressure-sensitive adhesive surface 20A of the pressure-sensitive adhesive sheet 1 (in the side where a pressure-sensitive adhesive layer 20 was formed) was fixed on SUS 304 stainless steel 132 using a double-sided pressure-sensitive adhesive tape 130. A single-sided pressure-sensitive adhesive tape 160 having an acrylic pressure-sensitive adhesive 162 on a polyester film (supporting film) 164 (trade name: “Cellotape (registered trade name)”, 24 mm width, manufactured by Nichiban Co., Ltd.) was cut into a 100 mm length piece. A pressure-sensitive adhesive surface 162 A of the pressure-sensitive adhesive tape 160 was press-bonded to a rear surface (that is, the surface of a top coat layer 14) 1A of the pressure-sensitive adhesive sheet 1 at a pressure of 0.25 MPa and at a rate of 0.3 m/min. The resulting sample was kept in the conditions of 23° C. and 50% RH for 30 minutes. Thereafter, the pressure-sensitive adhesive tape 160 was peeled from the rear surface 1A of the pressure-sensitive adhesive sheet 1 in the conditions of a peeling angle of 180 degrees and a peel rate of 0.3 m/min by using a universal tensile tester to measure the adhesive strength (A) [N/24 mm] at this time.

The rear surface adhesive strength (A) is preferably 4.5 N/24 mm or higher, more preferably 5.0 N/24 mm or higher, and furthermore preferably 5.5 N/24 mm or higher. If the adhesive strength is lower than 4.5 N/24 mm, sufficient adhesive strength cannot be obtained, pick-up properties are inferior, and the peeling workability of the protection film is lowered, and therefore, it is not preferable.

### <Adhesive Strength to Polarizing Plate: Initial Period>

A TAC polarizing plate (SEG1423DU polarizing plate, manufactured by NITTO DENKO CORPORATION, 70 mm in width and 100 mm in length) was allowed to stand in the environments of 23° C. and 50% RH for 24 hours, and then a 25 mm wide, 100 mm long, cut piece of each pressure-sensitive adhesive sheet (the pressure-sensitive adhesive surface of the pressure-sensitive adhesive layer) was laminated to the polarizing plate (TAC surface) at a pressure of 0.25 MPa and at a rate of 0.3 m/min to obtain an evaluation sample.

After the lamination, the sample was allowed to stand in the environments of 23° C. and 50% RH for 30 minutes, and then using a universal tensile tester, the adhesive strength to the polarizing plate (in initial period) (N/25 mm) was measured at the time of peeling the pressure-sensitive adhesive sheet at a peel rate of 30 m/min (high speed peeling) and a peeling angle of 180°. The measurement was performed in the environments of 23° C. and 50% RH.

### <Adhesive Strength (B) to Polarizing Plate: Over Time>

A TAC polarizing plate (SEG1423DU polarizing plate, manufactured by NITTO DENKO CORPORATION, 70 mm in width and 100 mm in length) was allowed to stand in the environments of 23° C. and 50% RH for 24 hours, and then a 25 mm wide, 100 mm long, cut piece of each pressure-sensitive adhesive sheet (the pressure-sensitive adhesive surface of the pressure-sensitive adhesive layer) was laminated to the polarizing plate (TAC surface) at a pressure of 0.25 MPa and at a rate of 0.3 m/min to obtain an evaluation sample.

After the lamination, the sample was allowed to stand in the environments of 50° C. for 1 week, and then using a universal tensile tester, the adhesive strength (B) to a polarizing plate (over time) (N/25 mm) was measured at the time of peeling the pressure-sensitive adhesive sheet at a peel rate of 30 m/min (high speed peeling) and a peeling angle of 180°. The measurement was performed in the environments of 23° C. and 50% RH.

Regarding the adhesive strength to a polarizing plate, both the adhesive strength to a polarizing plate (initial period) and the adhesive strength (B) to a polarizing plate (overtime) are preferably 1.5 N/25 mm or lower, more preferably 0.05 to 1.5 N/25 mm, and furthermore preferably 0.1 to 1.4 N/25 mm. If the adhesive strength (B) exceeds 1.5 N/25 mm, it becomes difficult to peel the protective film from an adherend, and peeling workability becomes inferior when the protective film is unnecessary, and further an adherend is damaged during the peeling step, and therefore, it is not preferable. In the case where an increase in the adhesive strength (B) to a polarizing plate (over time) is higher than that of the adhesive strength to a polarizing plate (initial period), ability to prevent an increase in adhesive strength over time are inferior, and therefore, it is not preferable.

### <Evaluation of Adhesive Strength Ratio (A/B)>

The adhesive strength ratio (A/B) of the adhesive strength (A) and the adhesive strength (B) is 3 or higher, preferably 3.5 or higher, and more preferably 4 or higher. If the ratio falls within the range, the pick-up properties are excellent, and it is a preferable embodiment.

### <Pick-Up Properties>

As shown in FIG. 2, each pressure-sensitive adhesive sheet 1 of respective Examples was cut into a piece in a size of 50 mm in width and 100 mm in length, and a pressure-sensitive adhesive surface 20A of the pressure-sensitive adhesive sheet 1 (in the side where a pressure-sensitive adhesive layer 20 was formed) was press-bonded onto a plane polarizing plate (SEG1425DU, TAC polarizing plate manufactured by NITTO DENKO CORPORATION) 50 at a pressure of 0.25 MPa and at a rate of 0.3 m/min.

A single-sided pressure-sensitive adhesive tape 60 (trade name: “Cellotape (registered trade name)”, 24 mm width, manufactured by Nichiban Co., Ltd.) was cut into a 50 mm length piece. A pressure-sensitive adhesive layer (pressure-sensitive adhesive surface) 62 of the pressure-sensitive adhesive tape 60 was press-bonded to the center of the rear surface (that is, the surface of a top coat layer 14) of the pressure-sensitive adhesive sheet 1 having a width of 50 mm by hands in a manner that one end of the piece protruded 30 mm. The resulting sample was kept in the conditions of 23° C. and 50% RH for 10 seconds. Thereafter, the single-sided pressure-sensitive adhesive tape 60 was peeled by hands and the peeling conditions of the pressure-sensitive adhesive sheet 1 (pick-up properties) were evaluated.

The evaluation standard was such that if the pressure-sensitive adhesive sheet was peelable, it was rated as ◯, and if the pressure-sensitive adhesive sheet could not be peeled and then left, it was rated as x.

### <Preparation of (Meth)Acryl-Based Polymer A>

A four-neck flask equipped with a stirring blade, a thermometer, a nitrogen gas introduction tube, and a condenser was charged with 100 parts by weight of 2-ethylhexyl acrylate (2EHA), 5 parts by weight of 4-hydroxybutyl acrylate (4HBA), 0.01 parts by weight of acrylic acid (AA), 0.2 parts by weight of 2,2′-azobisisobutyronitrile as a polymerization initiator, and 157 parts by weight of ethyl acetate, and nitrogen gas was introduced with mild stirring, and then polymerization reaction was performed for 6 hours while the liquid temperature in the flask was kept at about 65° C. to prepare a (meth)acryl-based polymer A solution (40% by weight). This acryl-based polymer A had a weight average molecular weight of 540,000 and a glass transition temperature (Tg) of −68° C.

Other (meth)acryl-based polymers ere prepared in the mixing proportion of Table 1 in the same manner as described above. The physical property values of the obtained polymers were also shown in Table 1.

### (Preparation of Acrylic Oligomer)

A four-neck flask equipped with a stirring blade, a thermometer, a nitrogen gas introduction tube, a condenser, and a titration funnel was charged with 100 parts by weight of toluene, 60 parts by weight of dicyclopentanyl methacrylate (DCPMA) (trade name: FA-513M, Hitachi Chemical Co., Ltd.), 40 parts by weight of methyl methacrylate (MMA), and 3.5 parts by weight of methyl thioglycolate as a chain transfer agent. After the mixture was stirred at 70° C. for 1 hour under a nitrogen atmosphere, 0.2 parts by weight of 2,2′-azobisisobutyronitrile as a polymerization initiator was charged, and reaction was performed at 70° C. for 2 hours, successively at 80° C. for 4 hours, and thereafter at 90° C. for 1 hour to obtain an acrylic oligomer. The acrylic oligomer had a weight average molecular weight of 4,000 and a glass transition temperature (Tg) of 144° C.

### <Preparation of Top Coat Layer E>

As a binder A, a dispersion containing 25% polyester resin (trade name: “Vylonal MD-1480”, (water dispersion of saturated copolymer polyester resin), manufactured by Toyobo Co., Ltd.) was prepared.

As a lubricant B, a water dispersion of carnauba wax was prepared, and further as an electroconductive polymer, an aqueous solution containing 0.5% poly(3,4-dioxythiophene) (PEDOT) and 0.8% polystyrene sulfonate (number average molecular weight 150,000) (PSS) (trade name: “Baytron P”, manufactured by H.C. Stark) was prepared.

To a solvent mixture of water and ethanol were added 100 parts by weight of the binder dispersion in solid content, 30 parts by weight of the lubricant dispersion in solid content, 50 parts by weight of the aqueous electroconductive polymer solution in solid content, and a melamine crosslinking agent, and the resultant was sufficiently mixed by stirring for about 20 minutes. In this way, a coating material having about 0.15% by weight of NV was prepared.

Successively, a transparent polyethylene terephthalate (PET) film S with 38 μm thickness, 30 cm width, and 40 cm length, which was a supporting film subjected to corona treatment in one surface (first surface), was prepared. The coating material was applied to the corona-treated surface of the PET film by a bar coater and dried by heating at 130° C. for 2 minutes. In this way, a supporting film (supporting film bearing top coat) having a transparent top coat layer E with 10 nm thickness on the first surface of the PET film was produced.

In the case where the thickness of the top coat layer E was set to 50 nm, the concentration of NV was adjusted to about 0.3% by weight to adjust the thickness, and other conditions were the same as those in the case of the 10 nm-thick transparent top coat layer E.

### <Preparation of Top Coat Layer F>

A solution was prepared which contained, as a binder C, an antistatic agent containing a cationic polymer (trade name: “Bondeip P main agent”, manufactured by Konishi Co., Ltd.), and as a curing agent, an epoxy resin (trade name: “Bondeip P curing agent”, manufactured by Konishi Co., Ltd.) at a weight ratio of 100:46.7 on NV basis in a water-alcohol solvent.

The solution was applied to the corona-treated surface of a transparent polyethylene terephthalate (PET) film with 38 μm thickness, 30 cm width, and 40 cm length, which was a supporting film subjected to corona treatment in one surface (first surface), and then dried to form a top coat layer with 0.06 g/m² on NV basis.

Successively, a long chain alkyl carbamate-based releasing agent (trade name: “Peeloil 1010”, manufactured by Ipposha Oil Industries Co., Ltd.) as a lubricant D was applied onto the surface of the top coat layer so as to have 0.02 g/m² on NV basis, and then dried to produce a top coat layer F provided with slip properties. In this way, a supporting film having a transparent top coat layer F with a thickness of 80 nm on the first surface of the PET film (top coat-bearing supporting film) was produced.

### Example 1

### Preparation of Pressure-Sensitive Adhesive Solution

The (meth)acryl-based polymer A solution (40% by weight) was diluted to 20% by weight with ethyl acetate, and to 500 parts by weight (100 parts by weight solid content) of the obtained solution were added 2 parts by weight of a solution (0.2 parts by weight solid content) obtained by diluting an organopolysiloxane (KF-353, manufactured by Shin-Etsu Chemical Co., Ltd.) to 10% with ethyl acetate, 5 parts by weight of a solution (0.05 parts by weight solid content) obtained by diluting lithium bis(trifluoromethanesulfonyl)imide (LiN(CF₃SO₂)₂:LiTFSI, manufactured by Tokyo Kasei Kogyo Co., Ltd.) to 1% with ethyl acetate as an alkali metal salt serving as an antistatic agent, 1 part by weight (1 part by weight solid content) of an isocyanurate of hexamethylene diisocyanate (COLONATE HX, manufactured by Nippon Polyurethane Industry Co., Ltd.) as a crosslinking agent, and 2 parts by weight (0.02 parts by weight solid content) of dibutyltin dilaurate (1% by weight ethyl acetate solution) as a crosslinking catalyst, and the resultant was mixed with stirring to prepare a pressure-sensitive adhesive composition A (an acrylic pressure-sensitive adhesive solution).

### [Production of Pressure-Sensitive Adhesive Sheet]

The acrylic pressure-sensitive adhesive solution was applied to the surface opposite to the top coat layer E of the supporting film having the top coat layer E, and heated at 130° C. for 2 minutes to form a 15 μm thick pressure-sensitive adhesive layer. Next, the silicone-treated surface of a polyethylene terephthalate film (thickness of 25 μm), which was a separator with one surface treated with silicone, was bonded to the surface of the pressure-sensitive adhesive layer A to produce a pressure-sensitive adhesive sheet.

### Examples 2 to 6, 10 and 11 and Comparative Examples 1 to 3

Pressure-sensitive adhesive sheets were produced in the same manner as in Example 1 according to the mixing proportion of the table. The mixing amount in the table was based on solid content. The additives which were not listed in the tables were added in the same mixing amount as in Example 1. The additives which were not specified in Examples 7 to 9 were the same as described above.

### Example 7

A pressure-sensitive adhesive sheet was produced in the same manner as in Example 1 according to the mixing proportions of Table 1 and Table 2, except that 1 part by weight of an acrylic oligomer was further added.

### Example 8

A pressure-sensitive adhesive sheet was produced in the same manner as in Example 1 according to the mixing proportions of Table 1 and Table 2, except that 0.5 parts by weight (0.005 parts by weight solid content) of tris(acetylacetonato) iron (1% by weight ethyl acetate solution) was used in place of dibutyltin dilaurate as a crosslinking catalyst.

### Example 9

A pressure-sensitive adhesive sheet was produced in the same manner as in Example 1 according to the mixing proportions of Table 1 and Table 2, except that 1 part by weight of an acrylic oligomer was further added and 0.5 parts by weight (0.005 parts by weight solid content) of tris(acetylacetonato)iron (1% by weight ethyl acetate solution) was used in place of dibutyltin dilaurate as a crosslinking catalyst.

TABLE 1

| | Monomer composition and physical | | | | | |
|---|---|---|---|---|---|---|
| | properties of obtained polymer | | | | | |
| Unit | | | | Physical property | | |
| (part by | | | | value of obtained polymer | | |
| weight) | | | | | | Content of |
| Obtained | Monomer component | | | Tg | | COOH monomer |
| polymer | 2EHA | 4HBA | AA | (° C.) | Mw | (% by weight) |
| A | 100 | 5 | 0.01 | −68 | 540,000 | 0.01 |
| B | 100 | 5 | 0.1 | −68 | 540,000 | 0.10 |
| C | 100 | 5 | 1 | −68 | 560,000 | 0.94 |
| D | 100 | 10 | 0.01 | −67 | 540,000 | 0.01 |
| E | 100 | 5 | — | −68 | 540,000 | 0.00 |
| F | 100 | 5 | 5 | −64 | 570,000 | 4.55 |

TABLE 2

| | Pressure-sensitive adhesive composition | | | | | | |
|---|---|---|---|---|---|---|---|
| Unit (part by weight) | | | | Organopolysiloxane | | Ionic compound | |
| Kind of | Obtained polymer | | Crosslinking | Kind | | Kind | |
| pressure-sensitive | | Mixing | agent | (product | Mixing | (product | Mixing |
| adhesive composition | Kind | amount | O/HX | name) | amount | name) | amount |
| A | A | 100 | 1 | KF353 | 0.2 | LiTFSI | 0.05 |
| B | B | 100 | 1 | KF353 | 0.2 | LiTFSI | 0.05 |
| C | C | 100 | 1 | KF353 | 0.2 | LiTFSI | 0.05 |
| D | B | 100 | 1 | KF353 | 0.2 | — | — |
| E | C | 100 | 1 | KF353 | 0.2 | — | — |
| F | A | 100 | 1.5 | KF353 | 0.2 | LiTFSI | 0.05 |
| G | D | 100 | 1.5 | KF353 | 0.2 | LiTFSI | 0.05 |
| H | D | 100 | 1.5 | KF353 | 0.2 | LiTFSI | 0.05 |
| I | E | 100 | 1 | KF353 | 0.2 | LiTFSI | 0.05 |
| J | F | 100 | 1 | KF353 | 0.2 | LiTFSI | 0.05 |
| K | A | 100 | 1.5 | KF353 | 0.2 | BMPTFSI | 0.1 |
| L | A | 100 | 1.5 | KF353 | 0.2 | BMPPF | 0.5 |

The abbreviations in Table 1 and Table 2 were as follows.

2EHA: 2-ethylhexyl acrylate

4HBA: 4-hydroxybutyl acrylate

AA: acrylic acid (carboxyl group-containing (meth)acryl-based monomer)

COOH monomer: carboxyl group-containing (meth)acryl-based monomer

C/HX: isocyanate compound, isocyanurate of hexamethylene diisocyanate (trade name; COLONATE HX, manufactured by Nippon Polyurethane Industry Co., Ltd)

KF353: organopolysiloxane (HLB value: 10, trade name: KF-353, manufactured by Shin-Etsu Chemical Co., Ltd.)

LiTFSI: alkali metal salt, lithium bis(trifluoromethanesulfonyl)imide, (LiN(CF₃SO₂)₂)₂), manufactured by Tokyo Kasei Kogyo Co., Ltd.)

BMPTFSI: ionic liquid (antistatic agent), 1-butyl-3-methylpyridinium bis(trifluoromethanesulfonyl)imide

BMPPF: ionic liquid (antistatic agent), 1-butyl-4-methylpyridinium hexafluorophosphate

TABLE 3

| Configuration of pressure-sensitive | | Example | | | | | | | | | | | Comparative Example | | |
|---|---|---|---|---|---|---|---|---|---|---|---|---|---|---|---|
| adhesive sheet and evaluation results | | 1 | 2 | 3 | 4 | 5 | 6 | 7 | 8 | 9 | 10 | 11 | 1 | 2 | 3 |
| Supporting film | | S | S | S | S | S | S | S | S | S | S | S | S | S | S |
| Top coat layer | Binder | A | A | A | A | A | A | A | A | A | A | A | C | A | A |
| | Lubricant | B | B | B | B | B | B | B | B | B | B | B | D | B | B |
| | Top coat layer | E | E | E | E | E | E | E | E | E | E | E | F | E | E |
| | Thickness [nm] | 10 | 50 | 50 | 50 | 50 | 50 | 50 | 50 | 50 | 50 | 50 | 80 | 50 | 50 |
| Pressure- | Pressure-sensitive | A | A | B | C | D | E | F | G | H | K | L | A | I | J |
| sensitive | adhesive | | | | | | | | | | | | | | |
| adhesive | composition | | | | | | | | | | | | | | |
| layer | Thickness [μm] | 15 | 15 | 15 | 15 | 15 | 15 | 15 | 15 | 15 | 15 | 15 | 15 | 15 | 15 |
| Whitening | Initial period | 0 | 0 | 0 | 0 | 0 | 0 | 0 | 0 | 0 | 0 | 0 | 0 | 0 | 0 |
| resistance | After heating and | 2 | 1 | 1 | 1 | 1 | 1 | 1 | 1 | 1 | 1 | 1 | 4 | 1 | 1 |
| | humidification | | | | | | | | | | | | | | |
| Solvent resistance | | Good | Good | Good | Good | Good | Good | Good | Good | Good | Good | Good | Poor | Good | Good |
| Rear surface | Cellotape | 7.0 | 6.4 | 6.4 | 6.4 | 6.4 | 6.4 | 6.4 | 6.4 | 6.4 | 6.4 | 6.4 | 1.0 | 6.4 | 6.4 |
| adhesive | [N/24 mm] | | | | | | | | | | | | | | |
| strength (A) | | | | | | | | | | | | | | | |
| Adhesive | Initial period | 1.2 | 1.2 | 1 | 1 | 1.1 | 1 | 0.9 | 0.6 | 0.6 | 0.8 | 0.7 | 1.2 | 1.4 | 1.8 |
| strength to | [N/25 mm] | | | | | | | | | | | | | | |
| polarizing plate | | | | | | | | | | | | | | | |
| Adhesive | 50° C. × 1 week | 1.2 | 1.2 | 0.7 | 0.9 | 0.9 | 0.7 | 1 | 0.7 | 0.6 | 0.9 | 0.7 | 1.2 | 2.4 | 5.8 |
| strength (B) to | [N/25 mm] | | | | | | | | | | | | | | |
| polarizing plate | | | | | | | | | | | | | | | |
| Adhesive | A/B | 5.8 | 5.3 | 9.1 | 7.1 | 7.1 | 9.1 | 6.4 | 9.1 | 10.7 | 7.1 | 9.1 | 0.8 | 2.7 | 1.1 |
| strength ratio | | | | | | | | | | | | | | | |

| | | | | | | | | | | | | | | |
|---|---|---|---|---|---|---|---|---|---|---|---|---|---|---|
| Pick-up properties | ∘ | ∘ | ∘ | ∘ | ∘ | ∘ | ∘ | ∘ | ∘ | ∘ | ∘ | x | x | x |
| Peeling electrification voltage [kV] | 0 | 0 | 0 | 0 | — | — | 0.1 | 0 | 0 | 0 | 0 | 0 | 0 | −1.4 |

Remark) The blank parts (—) in Table 3 indicate no evaluation for antistatic properties was performed since no ionic compound as an antistatic agent was added.

From the results in Table 3, in all Examples, acrylic acid (AA), which is a carboxyl group-containing (meth)acryl-based monomer, in a desired amount was added so that the pressure-sensitive adhesive sheets could be confirmed to be excellent in adherability, removability, ability to prevent an increase in adhesive strength, pick-up properties, and workability owing to these properties. Further, regarding Examples in which the ionic compound as an antistatic agent was added, it could be confirmed that the antistatic properties were also excellent.

On the other hand, in Comparative Example 1, the desired raw material was not used for the top coat layer, and therefore, the whitening resistance and the solvent resistance were inferior and the rear surface adhering strength (A) to the adhesive strength (B) to a polarizing plate was low, and the pick-up properties were also inferior.

Since no acrylic acid (AA) was used in preparing the pressure-sensitive adhesive composition in Comparative Example 2, it was confirmed that the adhesive strength (B) to a polarizing plate was high, ability to prevent an increase in adhesive strength were inferior, the adhesive strength ratio (A/B) was out of the desired range, the pick-up properties were inferior, and workability were inferior.

Since a large amount of acrylic acid (AA) was added in preparing the pressure-sensitive adhesive composition in Comparative Example 3, it was confirmed that the adhesive strength to a polarizing plate in initial period and the adhesive strength (B) to a polarizing plate showed extremely high values, ability to prevent an increase in adhesive strength were inferior, the adhesive strength ratio (A/B) was out of the desired range, the pick-up properties were inferior, and workability were inferior. In Comparative Example 3, although an antistatic agent was added, the antistatic properties were inferior since a large amount of acrylic acid was added.

### EXPLANATION OF SYMBOLS

1 Pressure-sensitive adhesive sheet (surface protective film)
1A Surface of top coat layer
2 Polarizing plate
3 Acrylic plate
4 Fixation stand
5 Potentiometer
12 Supporting film
14 Top coat layer
20 Pressure-sensitive adhesive layer
20A Pressure-sensitive adhesive surface
50 Plane polarizing plate
60 Single-sided pressure-sensitive adhesive tape
62 Pressure-sensitive adhesive layer (pressure-sensitive adhesive surface)
64 Substrate
130 Double-sided pressure-sensitive adhesive tape
132 Stainless plate
160 Single-sided pressure-sensitive adhesive tape
162 Acrylic pressure-sensitive adhesive (pressure-sensitive adhesive layer)
162A Pressure-sensitive adhesive surface
164 Polyester film (supporting film)

1. A pressure-sensitive adhesive sheet having a supporting film, a pressure-sensitive adhesive layer formed from a pressure-sensitive adhesive composition on one surface of the supporting film, and a top coat layer on the other surface opposite to the surface having the pressure-sensitive adhesive layer of the supporting film, wherein
the top coat layer contains wax as a lubricant and a polyester resin as a binder; and
an adhesive strength ratio (A/B) of the rear surface adhesive strength (A) at a peel rate of 0.3 m/min after the surface of the top coat layer is bonded at 23° C. for 30 minutes and the adhesive strength (B) at a peel rate of 30 m/min after the pressure-sensitive adhesive surface of the pressure-sensitive adhesive layer is bonded to a TAC surface at 50° C. for 1 week is 3 or higher.

2. The pressure-sensitive adhesive sheet according to claim 1, wherein the adhesive strength (B) is 1.5 N/25 mm or lower.

3. The pressure-sensitive adhesive sheet according to claim 1, wherein the pressure-sensitive adhesive composition contains a (meth)acryl-based polymer containing a hydroxyl group and a carboxyl group.

4. The pressure-sensitive adhesive sheet according to claim 3, which contains the carboxyl group-containing (meth)acryl-based monomer in an amount of 2% by weight or less based on the total weight of the monomer components constituting the (meth)acryl-based polymer.

5. The pressure-sensitive adhesive sheet according to claim 3, which contains the hydroxyl group-containing (meth)acryl-based monomer in an amount of 15% by weight or less based on the total weight of the monomer components constituting the (meth)acryl-based polymer.

6. The pressure-sensitive adhesive sheet according to claim 3, which contains a (meth)acryl-based monomer containing an alkyl group of 1 to 14 carbon atoms in an amount of 50% by weight or more-based on the total weight of the monomer components constituting the (meth)acryl-based polymer.

7. The pressure-sensitive adhesive sheet according to claim 1, wherein the pressure-sensitive adhesive composition contains a crosslinking agent.

8. The pressure-sensitive adhesive sheet according to claim 1, wherein the pressure-sensitive adhesive composition contains an organopolysiloxane having an oxyalkylene chain.

9. The pressure-sensitive adhesive sheet according to claim 1, wherein the pressure-sensitive adhesive composition contains an ionic compound.

10. The pressure-sensitive adhesive sheet according to claim 1, wherein the wax is an ester of a higher fatty acid and a higher alcohol.

11. The pressure-sensitive adhesive sheet according to claim 1, wherein the top coat layer contains an antistatic component.

12. An optical member protected with the pressure-sensitive adhesive sheet according to claim 1.

13. An optical member protected with the pressure-sensitive adhesive sheet according to claim 2.

14. An optical member protected with the pressure-sensitive adhesive sheet according to claim 3.

15. An optical member protected with the pressure-sensitive adhesive sheet according to claim 4.

16. An optical member protected with the pressure-sensitive adhesive sheet according to claim 5.

17. An optical member protected with the pressure-sensitive adhesive sheet according to claim 6.

18. An optical member protected with the pressure-sensitive adhesive sheet according to claim 7.

19. An optical member protected with the pressure-sensitive adhesive sheet according to claim 8.

20. An optical member protected with the pressure-sensitive adhesive sheet according to claim 9.

21. An optical member protected with the pressure-sensitive adhesive sheet according to claim 10.

22. An optical member protected with the pressure-sensitive adhesive sheet according to claim 11.
